(19) United States
(12) Patent Application Publication
(10) Pub. No.: US 2012/0065561 A1
(43) Pub. Date: Mar. 15, 2012

(54) DEVICE, SYSTEM, AND METHOD FOR THE TREATMENT, PREVENTION AND DIAGNOSIS OF CHRONIC VENOUS INSUFFICIENCY, DEEP VEIN THROMBOSIS, LYMPHEDEMA AND OTHER CIRCULATORY CONDITIONS

(75) Inventors: MICHAEL THOMAS BALLAS, SNOHOMSIH, WA (US); GARY JOSEPH BALLAS, REDMOND, WA (US); EDWARD BERMAN, SEATTLE, WA (US); THOMAS E. UDD, SULTAN, WA (US); CAREY M. GOLDEN, WOODINVILLE, WA (US); NICHOLAS LOCKEN, MONROE, WA (US)

(73) Assignee: EPOCH MEDICAL INNOVATIONS, INC., SEATTLE, WA (US)

(21) Appl. No.: 13/226,386

(22) Filed: Sep. 6, 2011

Related U.S. Application Data
(60) Provisional application No. 61/380,198, filed on Sep. 3, 2010.

(51) Int. Cl. A61H 7/00

(52) U.S. Cl. 601/152

(57) ABSTRACT

A compression device for applying compression to an extremity of a mammal includes a cuff adapted to be placed around and secured to the extremity. A control and tensioning unit is attached to the cuff and is operable to control a tension of the cuff to thereby control the compression applied to the extremity. The cuff may further include a bladder system, in which case the compression device further includes a hydraulic pump that is operable to transfer fluid within the bladder system to control the compression applied to the extremity.

### PRIORITY CLAIM

The present application claims the benefit of copending U.S. Provisional Patent Application No. 61/380,198, filed Sep. 3, 2010, which application is incorporated herein by reference in its entirety.

### TECHNICAL FIELD

The present disclosure relates generally to circulatory conditions such as chronic venous insufficiency (CVI), deep vein thrombosis (DVT), and lymphedema, and more specifically to devices that apply compressive pressure on extremities for the treatment, prevention, and diagnosis of CVI, DVT, lymphedema, and related circulatory conditions.

### BACKGROUND

A variety of circulatory conditions exist in which compressive pressure, typically intermittent compressive pressure, is applied to the extremities of a patient in order to improve the flow of some fluid in the patient's body. Three such circulatory conditions are deep vein thrombosis, chronic venous insufficiency, and lymphedema. With regard to deep vein thrombosis, which is also referred to more generally as venous thrombosis, current estimates are that in the United States alone about two million people develop deep vein thrombosis each year, and over 600,000 of those people are hospitalized because of the condition. Deep vein thrombosis is known to be associated with the risk of developing a pulmonary embolism, which is a blockage of the main artery of the lung resulting from clot that has traveled from elsewhere in body, and in this case from the thrombus or clot associated with the deep vein thrombosis. Pulmonary embolisms are the third most common cause of death in the United States so prevention and early diagnosis of deep vein thrombosis that can lead to pulmonary embolisms are of great importance in reducing the number of related deaths.

Chronic venous insufficiency is a condition in which the veins of a patient's body cannot pump enough oxygen-poor blood back to the patient's heart. Chronic venous insufficiency of the lower extremities is a condition caused by abnormalities of vein walls and of valves within these veins, leading to the obstruction or reflux of blood flow in the veins. The term “lower extremities” as used herein includes the hip region, thigh region, calf region, ankle, and the foot of a patient, and the term “extremities” includes the lower extremities plus the arms of the patient. Lymphedema is a similar condition that occurs when the lymphatic system of a patient is not able to clear fluid from the interstitial tissues of the body and return it to the bloodstream via the system's lymphatic vessels and lymph nodes. With chronic venous insufficiency and lymphedema poor flow of blood and other bodily fluids, respectively, in the extremities may cause chronic swelling, inflammation, ulcerations and pain that contribute to other medical problems. These problems, along with deep vein thrombosis, may arise in surgical patients and are increasingly common in otherwise healthy people having occupations that require sitting for long periods of time as part of their work, or as a result of frequent travel.

Current solutions for treating venous thrombosis involve applying intermittent compression to extremities. A pneumatically inflatable device is placed around the extremity to apply the desired compression, with these pneumatic devices being tethered to an external unit including an electric motor or pump and to an air or other gaseous source. As a result, the devices are bulky and awkward, often having exposed wires and tubing that make the devices prone to misuse, nonuse, and making them difficult to maneuver and thus not portable. Traditional methods of diagnosing venous thrombosis include various forms of impedance plethysmography, in which changes in venous blood volume and pressure (and by extension changes in volume and pressure in the limbs) during an arterial pulse cycle are compared to known baseline measurements, as will be understood by those skilled in the art.

Chronic venous insufficiency treatment is aimed at alleviating symptoms and, whenever possible, at correcting the underlying abnormality. For chronic venous insufficiency, graduated compression is the cornerstone of modern treatment. Properly fitted compression stockings provide compression starting at the patient's ankle, with the pressure gradually decreasing at more proximal levels of the leg (i.e., as you move up the leg towards the hip region). The compression is sufficient to restore normal venous flow patterns in many or even most patients with superficial venous reflux, and to improve venous flow in patients with severe deep venous incompetence.

Lymphedema can occur in a variety of different scenarios. It can be inherited and can also arise after lymph nodes are removed and as a result of radiation therapy, both of which typically occur during cancer diagnosis and treatment. As with deep vein thrombosis and chronic venous insufficiency, compression garments are also utilized in the treatment of lymphedema. Compression bandaging restores shape to the limb and/or affected area, reduces skin changes such as ulcerations, supports overstretched skin, and softens subcutaneous tissues. Pneumatic compression devices are also widely used in the treatment of lymphedema.

Whether the condition is deep vein thrombosis, chronic venous insufficiency, or lymphedema, current compression devices, including both inelastic compression devices like compression stockings and bandages as well as pneumatic compression devices that apply dynamic compression, are not well suited to portability. These devices also are many times difficult for patients to independently operate or utilize. Application of inelastic compression devices many times requires a trained healthcare professional to properly apply the compression bandages, and the same is true regarding the fitting and use of pneumatic compression devices. This lack of portability and difficulty of independent patient use reduces patient utilization of such compression devices, even where utilization would benefit the patient.

There is a need for improved compression devices for the treatment, prevention, and diagnosis of conditions such as deep vein thrombosis, chronic venous insufficiency, and lymphedema, with the compression device being portable, comfortable for patients to wear, and allowing easier patient operability of the device.

### SUMMARY

One embodiment described in the present invention is directed to a compression device for applying compression to an extremity of a mammal. The compression device includes a cuff adapted to be placed around and secured to the extremity. A control and tensioning unit is attached to the cuff and is operable to control a tension of the cuff to thereby control the compression applied to the extremity. The cuff may further include a bladder system, in which case the compression device further includes a hydraulic pump that is operable to transfer fluid within the bladder system to control the compression applied to the extremity.

### BRIEF DESCRIPTION OF THE DRAWINGS

FIG. 1 is diagram showing a compression system including compression devices worn on respective extremities of a patient according to one embodiment of the present invention.

FIG. 2 is an exploded view illustrating in more detail one embodiment of one of the compression devices of FIG. 1.

FIG. 3 is an exploded view illustrating in more detail the cuff portion contained in each of the compression devices of FIG. 2.

FIGS. 4A and 4B are cross-sectional views of the cuff of FIG. 3 in position around the calf of the patient of FIG. 1.

FIGS. 5A and 5B are cross-sectional views of another embodiment of a cuff for use in the compression devices of FIGS. 1 and 2.

FIGS. 6A and 6B are cross-sectional views of another embodiment of a cuff for use in the compression devices of FIGS. 1 and 2.

FIGS. 7A and 7B are cross-sectional views showing yet another embodiment of a cuff for use in the compression devices of FIGS. 1 and 2.

FIG. 8 is a diagram of a compression system on the legs of a patient in which the compression system includes multiple interconnected compression devices according to another embodiment of the present invention.

FIG. 9A is a cross-sectional view of a controlled inelastic compression device according to another embodiment of the present invention.

FIG. 9B is a flowchart illustrating one embodiment of a control process executed by the controlled inelastic compression device of FIG. 9A in applying a controlled compression profile to an extremity of the patient.

FIG. 9C is a graph illustrating an example of a compression profile applied to the extremity of an ambulatory patient during the process of FIG. 9B.

FIG. 9D is a graph illustrating a moving average of the pressure in the compression profile of FIG. 9C during the process of FIG. 9B.

FIG. 9E is a graph illustrating control of the circumference and circumferential displacement of the controlled inelastic compression device of FIG. 9A during execution of the process of FIG. 9B.

FIG. 9F is a graph illustrating an example of a compression profile applied to the extremity of a non-ambulatory patient by the controlled inelastic compression device of FIG. 9A.

FIG. 9G is a graph illustrating a moving average of the pressure in the compression profile of FIG. 9F.

FIG. 9H is a graph illustrating control of the circumference and circumferential displacement of the controlled inelastic compression device of FIG. 9A in applying the non-ambulatory compression profile of FIG. 9F.

FIG. 10 is a perspective front view illustrating in more detail another embodiment of the compression device of FIG. 9A.

FIG. 11 is a perspective top view of the compression device of FIG. 10.

FIG. 12 is a magnified perspective front view of the compression device of FIG. 10 showing the insertion of a slip compression band through the control and tensioning unit.

FIG. 13 is a perspective front view illustrating the slip compression bands of the compression device of FIG. 10 without the fluid-filled outer sleeves being attached thereto.

FIG. 14A is a functional cross-sectional view showing a control and tensioning unit, slip compression band, and fluid-filled outer sleeve of the compression device of FIG. 10.

FIG. 14B is a functional plan view of another embodiment of the compression devices of FIGS. 9A and 10.

FIG. 14C is a functional plan view of yet another embodiment of the compression devices of FIGS. 9A and 10.

FIG. 15 is a functional block diagram of one embodiment of the control and tensioning unit contained in the compression device of FIG. 10.

FIG. 16 is a flowchart showing the operation of the control unit of FIG. 15 during a compression cycle of the associated compression device.

FIG. 17 is a functional diagram illustrating the three different compression states described in the flowchart of FIG. 15.

### DETAILED DESCRIPTION

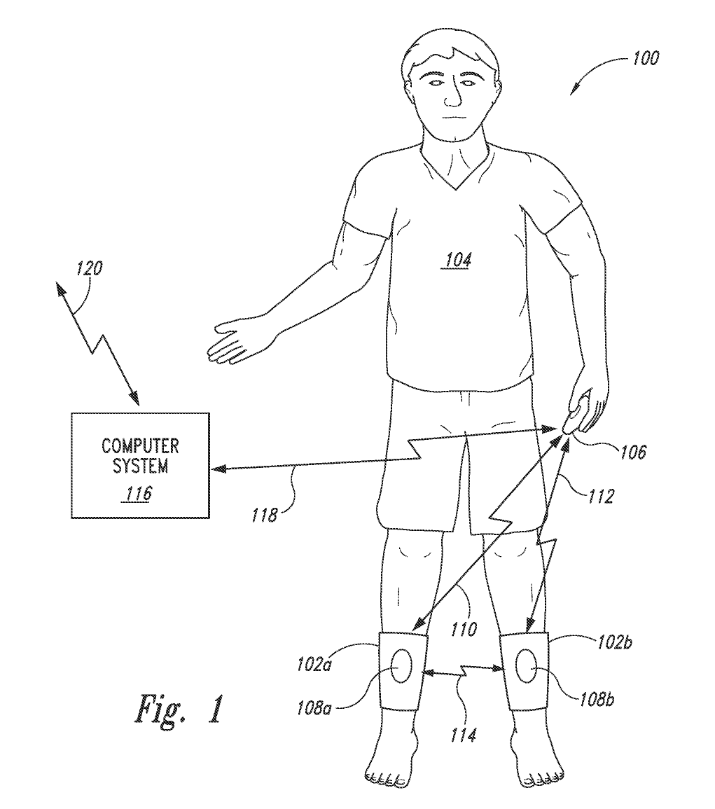

FIG. 1 is diagram showing a compression system 100 that includes compression devices 102a, 102b, each device being worn on a respective calf or other extremity of a patient 104, according to one embodiment of the present invention. Each compression device 102a, 102b is operable to apply intermittent, cyclical, or what is termed “controlled inelastic compression” to an extremity of the patient 100, as will be described in more detail below. In this way, the compression devices 102a, 102b can be utilized in the treatment, diagnosis, and prevention of circulatory conditions such as deep vein thrombosis, chronic venous insufficiency, and lymphedema, as will also be described in more detail below.

In the present description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Alternative embodiments including fewer than all the components or steps of any of the respective described embodiments may also be within the scope of the present invention although not expressly described in detail below. Finally, the operation of well-known components and/or processes has not been shown or described in detail below to avoid unnecessarily obscuring the present invention.

Also note that in the present description when there is more than one of the same component, such as the compression devices 102a, 102b of FIG. 1, each of the components will be assigned a respective reference descriptor including the same number and a different alphabetic character. When referring to a particular one of the components the complete reference descriptor, both number and letter will be used, and when referring generally to any or all of the components only the number portion of the reference descriptor may be used in the following description.

The compression system 100 further includes a remote control unit 106 that communicates with control units 108a and 108b contained in the compression devices 102a and 102b, respectively. Although the embodiment of FIG. 1 utilizes wireless communications, a wired alternative embodiment is also envisioned. The remainder of this description will refer to the preferred wireless version, yet it is to be understood that a wired version can perform the same functions as is described for the wireless version. The wireless communication between the remote control unit 106 and control units 108a, 108b is illustrated in FIG. 1 through wireless communication links 110 and 112. Each of control units 108 and remote control unit 106 may include an operator interface having suitable components (e.g., buttons and displays) that enable the patient 104, or a physician or other health care professional, to control the operation of the compression device 102. Some control modes of the compression devices 102a, 102b and the control units 108 may be limited to operation by a physician or health care professional only (i.e., may not be controlled by the patient), so the term “user” will be used in the following description of control possibilities to indicate a person having full access to all control modes. The patient 104 thus has access to a subset of all the control modes while a user has access to all control modes. Either the patient or the user may accordingly control the operation of the compression devices 102a, 102b, but the patient's control is more limited than that of a user.

Through the control units 108a, 108b or remote control unit 106 the user can turn the compression devices 102 ON and OFF and can also control various operating parameters of the compression devices, such as setting desired pressure, displacement, and elasticity characteristics of each device. Additional operating parameters that the user can control through the control units 108a, 108b and remote control unit 106 include setting desired intermittent, cyclic, or other controlled compression profiles for the compression devices 102. A compression profile defines the pressure that the compression device 102 applies to the patient extremity (i.e., calf of the patient 104 in the example of FIG. 1) as a function of time or some other characteristic of the patient, such as the ambulatory state the patient. For example, the user may utilize the control units 108a, 108b or remote control unit 106 to select a desired therapeutic compression profile or may place the compression devices in a constant circumferential mode of operation, as will be described in more detail below. Note the operator interfaces and functionality provided by the control units 108a, 108b and remote control unit 106 need not be identical. For example, the remote control unit 106 may contain a more sophisticated operator interface including a larger display and more buttons or other user inputs to more easily allow the user to control operation of the device 102. The control units 108a, 108b, conversely, may each contain a more limited operator interface that provides a patient 104 with more limited functional control of the compression device 102.

The remote control unit 106 or control units 108a, 108b may also be utilized to control the overall independent or coordinated operation of the individual compression devices 102 and additional compression devices (not shown in FIG. 1) where the patient 104 is also wearing such additional devices. For example, each of the compression devices 102, and any additional compression devices worn by the patient 104, may be controlled to operate asynchronously or independent of the other devices. Conversely, the operation of the multiple compression devices 102 may be coordinated or synchronized. When operating synchronously, the individual control units 108a, 108b and any additional control units associated with additional compression devices may also communicate with one another, which is illustrated in FIG. 1 through the communications link 114.

The user can also utilize the remote control unit 106 to place the compression devices 102 in a diagnostic mode of operation in which the compression devices apply appropriate compression profiles to establish baseline vital signs for the patient 104 and determine required physiological characteristics of the patient. In the diagnostic mode of operation, each of the compression devices 102 applies the appropriate compression profiles and gathers patient data corresponding to these applied profiles. A computer system 116 receives this patient data gathered by the compression devices 102, either directly from the compression devices or via the remote control unit 106 as is the case illustrated in FIG. 1 where the remote control unit communicates with the computer system via a communications link 118 to receive the patient data.

A physician (not shown in FIG. 1) or other user can then utilize the computer system 116 to monitor the received patient data and thereby diagnose circulatory conditions of the patient 104. The physician can also utilize the computer system 116 to monitor conditions of the patient 104 and adjust compression profiles that the compression devices 102 apply to the patient in response to the monitored conditions. The physician could be located proximate the computer system 116, such as where the computer system is located in a hospital room where the patient 104 is being treated. Alternatively, the physician may be located remotely and communicate with the computer system 116 through a suitable communications link 120, where such a communications link may take a variety of different suitable forms and may include the Internet. In this way, the computer system 116 could be located in the home of the patient 104 and allow a physician treating the patient to do so remotely via the communications link 120. The communications links 110, 112, 114 and 118 may be any suitable type of wireless communications, such as Wi-Fi or Bluetooth.

The compression system 100 allows the compression devices 102 to gather patient data and this data to be supplied to the computer system 116 for use by others. In some embodiments, caregivers can review usage data and physiological data transmitted by the compression devices 102 to the computer system 116. Using this data, the caregiver may then utilize the computer system 116 to provide new therapy sequences for treatment of the patient 104 to the compression devices 102 over the communications link 118. The wireless remote control unit 106 allows the patient 104 to control the compression devices 102 without touching the device. In some embodiments, the remote control unit 106 allows the patient 104 to enter commands in response to menu on an operator interface (not shown) of the remote control unit 106.

In other embodiments, the remote control unit 106 is operable to transmit commands to the compression devices 102 in response to simply tapping of the remote control unit, with the remote control unit including one or more inertial sensors to detect the motion of the unit. Such an embodiment could be particularly helpful where the patient 104 has limited mobility, and in cases where multiple compression devices 102 are utilized so that the patent need not individually program each compression device.

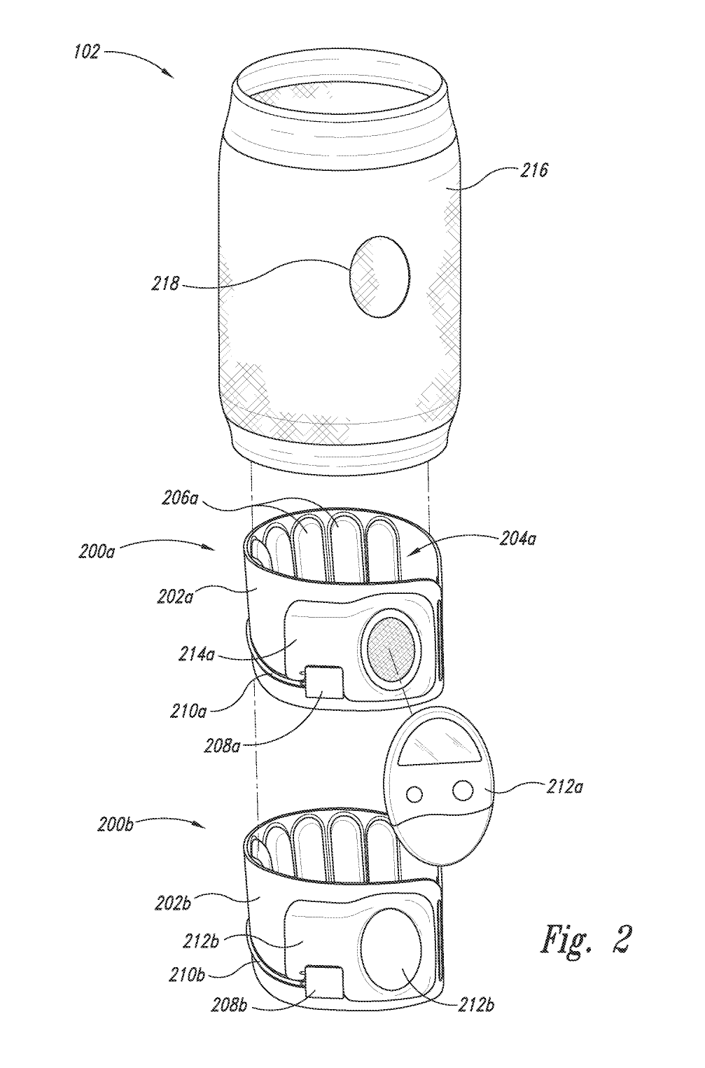

FIG. 2 is an exploded view illustrating in more detail an embodiment of one of the compression devices 102 of FIG. 1. In the embodiment of FIG. 2, the compression device 102 includes two cuffs 200a and 200b, each cuff being configured so that it may be positioned around the calf of the patient 104 (FIG. 1) and secured in place. The specific way in which each cuff 200a, 200b is secured in place may vary, and includes suitable hooks, snaps Velcro, and so on, as will be appreciated by those skilled in the art. Furthermore, in some embodiments of the compression devices 102 each include a friction or other suitable drive mechanism that secures the compression device in place around an extremity of the patient 104 and also controls the circumference of the cuff to thereby control the pressure applied to or compression of the patients extremity, as will be described in more detail below.

In the embodiment of FIG. 2, the cuff 200a further includes a hoop stress band 202a having a bladder system 204a attached thereto, with the bladder system including a number of membranes 206a that function to expand or contract radially in response to a fluid being pumped into or pumped from the membranes. A pump 208a is coupled to the membranes 206a through a porting assembly 210a and operates to pump fluid into or from the membranes responsive to control signals from a control unit 212a. The pump 208a is also coupled to a fluid reservoir 214a into which fluid is pumped when the membranes 206a are to be contracted and from which fluid is pumped when the membranes are to be expanded. The control unit 212a also includes sensors (not shown) such as pressure sensors, flow rate sensors, and inertial sensors that enable the control unit to control the pump 208a and fluid in the membranes 206a to thereby apply the desired compression profile to the calf of the patient 104 (FIG. 1), as will be described in more detail below. In other embodiments, these sensors are contained not in the control unit 212a but are contained in the cuff 200a and electrically coupled to the control unit.

The cuff 200b includes the same components 202a-210a and 214a as does the cuff 200a so like components for the cuff 200b have been given the same reference numbers as the corresponding components for the cuff 200a along with the letter reference “b.” A control unit 212b couples to cuff 200b and operates in the same way as described for control unit 212a. Note that the control units 212a and 212b correspond to the control unit 108a or 108b of FIG. 1, and that typically only one of the control units 212a, 212b would include an operator interface and would communicate required control information to the other control unit. Finally, the compression device 102 further includes a protective outer sleeve 216 that is attached around the calf of the patient 104 (FIG. 1) and over the cuffs 200a and 200b to protect both the cuffs and the patient's leg while the patient is wearing the compression device 102. The protective outer sleeve 216 may, for example, be made from an absorbent material to protect the cuffs 200a, 200b from liquids such as water. The sleeve 216 may have no connection mechanism but be made of a suitably elastic material that allows the sleeve to be slipped onto the leg of the patient 104 and then slid into place over the cuffs 200a, 200b. Alternatively, the sleeve 216 may include a suitable connection mechanism (not shown in FIG. 2), such as hooks, straps, Velcro, and so on, which allows the sleeve to be secured in place over the cuffs 200a, 200b. An aperture 218 in the protective outer sleeve 216 allows the patient 104 to access one of the control units 212a, 212b when the protective outer sleeve 216 is in position over the cuffs 200a, 200b.

Referring to FIGS. 1 and 2, in operation the cuffs 200a and 200b are first secured in place on the appropriate extremities of the patient 104, which are the calves of the patient the embodiment being described. Once the cuffs 200 are secured in place, the protective outer sleeve 216 is thereafter similarly secured in place over the cuffs. The patient 104 or a physician thereafter utilizes the control units 212a, 212b to place the compression devices 102 in the desired modes of operation. Once in the selected mode of operation, the control unit 212 controls the pump 208 to place the required amount of fluid in the membranes 206 of the bladder system 204. This fluid in the membranes 206 applies radial pressure to the calf of the patient 104 such that the compression device 102 applies the desired compression profile to the calf of the patient. In addition, the control unit 212 may also gather data using sensors contained in the control unit and supply this data to the computer system 116 through the remote control unit 106, such that a physician or program running on the computer system can analyze the data and utilize it in diagnosing a condition of the patient 104, monitor vital signs of the patient to detect whether treatment of the patient working, and so on.

As previously mentioned, the embodiment of the compression device 102 illustrated in FIGS. 1 and 2 is intended to be utilized on the calf of the patient 104, as shown in FIG. 1. Other embodiments of the compression device 102, however, have different forms that enable the device to be placed on other extremities of the patient 104, such as the patient's ankles, wrists, arms, and thighs.

In the compression device 102, the control unit 211 can control the pump 208 in the cuffs 200 in a variety of different ways. The pump 208 in a given cuff 200 can be actuated to pulse synchronously with the pumps in other cuffs, or the pumps can be actuated asynchronously, or sequentially such as where a series of cuffs are worn on a patient's legs and cuffs 200 are sequentially activated from bottom to top to remove unwanted fluid build-up in the patient's legs. The pumps 208 in respective cuffs 200 can also be actuated intermittently or the pumps in multiple cuffs actuated concurrently in accordance with programmed courses of therapy, or in accordance with programmed responses to input from the patient 104, or from caregivers or from feedback provided by sensors and valve systems (not shown) contained in the compression devices 102.

In some embodiments, compression cycling can be timed with sensor inputs of vital signs of the patient 104 such as heart rate, breathing rate, respiratory rates, venous flow, blood pressure and activity levels. Embodiments of the compression devices 102 are portable, low cost, and the device or portions thereof, such as the outer sleeve 216 and all components of the cuff 200 except for the control unit 211, can even be disposable. The compression device 102 also provide self-contained operation such that no exposed tubes or wires are required in connection with use of the device. Such self-contained compression devices 102 include rechargeable or disposable batteries in some embodiments that allow the devices to be worn at all times by the patient 104, even when walking and sleeping, and during immersion in water and during inclement weather, for many hours each day over an extended number of day. The operation of the compression devices 102 may also be very quiet, allowing the patient 104 to more comfortably wear the devices without distraction. The compression devices 102 can also be used to provide massage to the extremities of the patient 102 even when sequential compression is medically unnecessary. The improved portability, length of operation, and comfort, should increase the willingness of the patient 104 to use the compression devices 102 for longer therapeutic periods, thereby improving the likelihood of a favorable outcome from the treatment.

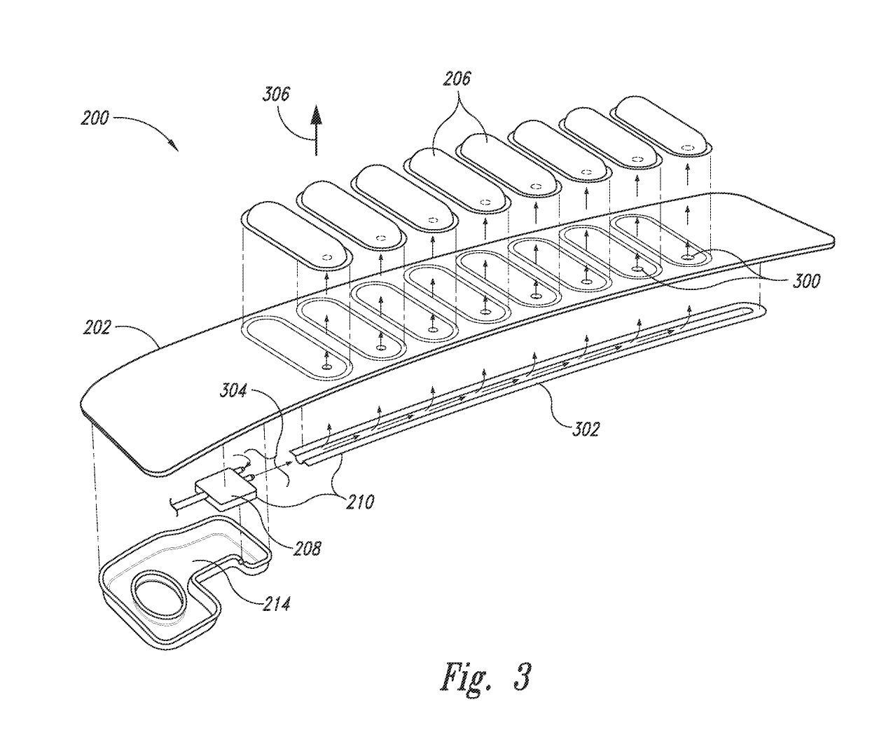

FIG. 3 is an exploded view illustrating in more detail the cuff 200 contained in each of the compression devices 102 of FIG. 2. The hoop stress band 202 has a number of orifices 300 formed therein, each orifice being configured to provide a fluid opening into a corresponding membrane 206 when the membrane is attached to a first side of the hoop stress band. A manifold 302, which is part of the porting assembly 210, attaches to a second side of the hoop stress band 202, with the second side opposing the first side as illustrated. The porting assembly 210 further includes nozzles 304 on the pump 208. The nozzles 304 are coupled to the manifold 302 and the manifold, pump 208, and fluid reservoir 214 are attached to the second side of the hoop stress band 202. In operation, the pump 208 transfers fluid between the manifold 302 and fluid reservoir 214 responsive to control signals from control circuitry (not shown) contained in the control unit 212.

To increase the radial pressure applied by the membranes 206, the pump 208 is controlled to pump fluid from the reservoir 214 into the manifold 302 and from the manifold through the orifices 300 and into the membranes 206. When fluid is pumped into the membranes 206, the membranes expand and apply pressure in the direction indicated by the arrow 304, which is termed a “radial” direction or pressure given that when the cuffs 200 is wrapped around the calf of the patient 104 this pressure is applied inward towards the center of the calf. Conversely, in order to lower the radial pressure applied by the membranes 206, the pumped 208 is controlled to pump fluid from the manifold 302 into the fluid reservoir 214. As fluid is removed from the manifold 302 the fluid contained in the membranes 206 flows through the orifices 300 and into the manifold, reducing the radial pressure applied by the membranes.

In one embodiment of the cuff 200, the fluid reservoir 214 includes a pressure-sensitive bellows (not shown in FIG. 3) that adjusts the volume of the reservoir to ensure that fluid contained in the reservoir is always available to the pump 208 regardless of orientation of the cuff. For example, if the reservoir 214 is not completely filled with fluid then in certain orientations of the cuff 200 (i.e., of the patient 104 wearing the cuff) the force of gravity could result in the fluid contained in the reservoir not being properly supplied to the pump 208. This could occur when the reservoir 214 is partially filled with fluid and oriented such that the force of gravity causes the fluid to pool at one of fluid reservoir that is opposite an outlet connected to the pump 208. In this situation the pump 208 would be “starved” in that no fluid can be supplied to the pump 208 for transfer to the membranes 206 as required to apply the desired compression profile. The pressure-sensitive bellows ensures that as fluid is removed from the fluid reservoir 214 the remaining fluid contained in the fluid reservoir is available at the outlet connected to the pump 208 so that regardless of orientation of fluid reservoir and cuff 200 the required fluid is available for the pump 208.

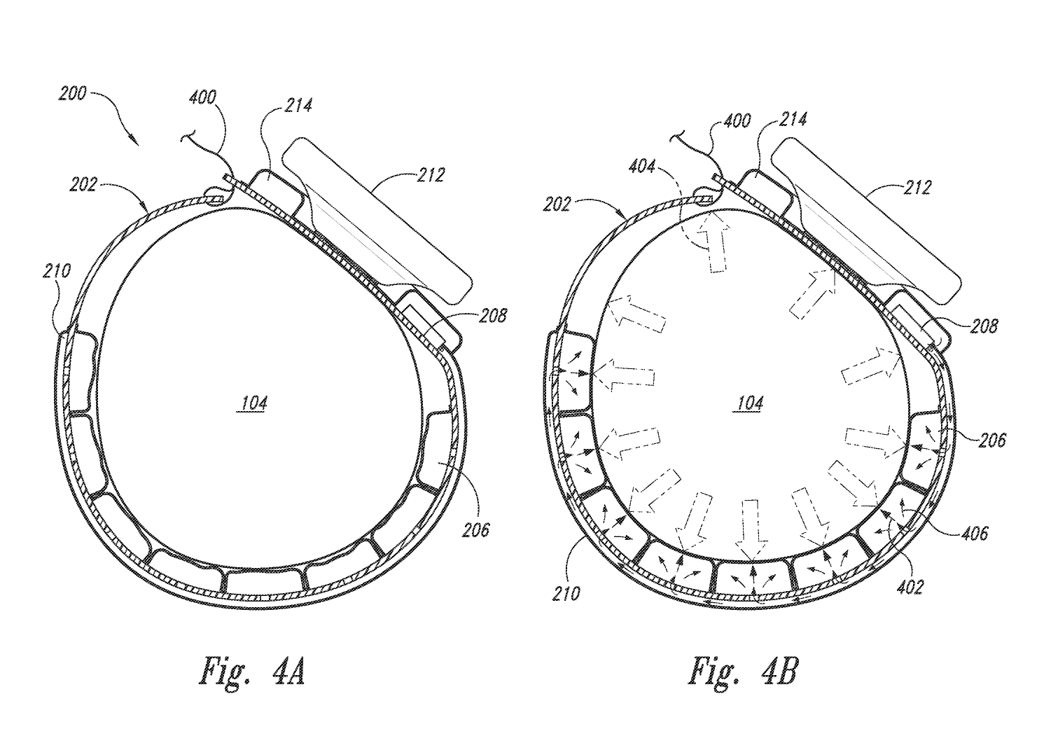

FIGS. 4A and 4B are cross-sectional views of the cuff 200 of FIG. 3 in position around the calf of the patient 104 of FIG. 1. As seen in FIGS. 4A and 4B, the porting assembly 210 is attached to the second side of the hoop stress band 202, which is the outer side when the cuff is positioned around the calf. The first side of the hoop stress band 202 is thus an inner side facing the leg of the patient 104. A sample attachment device 400 is shown in the cross-sectional views of FIGS. 4A and 4B to attach the cuff 200 around the leg of the patient 104. In FIG. 4A the membranes 206 are contracted relative to the membranes in FIG. 4B, meaning that a smaller radial pressure is applied to the leg of the patient 104 in FIG. 4A compared to FIG. 4B. In FIG. 4B, an arrow 402 indicates the radial pressure applied by the cuff 200. This radial pressure represented by the arrow 402 is greater in FIG. 4B due to the expanded membranes 206 (i.e., the pump 208 as pumped fluid from the fluid reservoir 214 and through the porting assembly 210 into the membranes 206 to thereby cause them to expand). Arrows 404 represent the outward pressure from the leg of the patient 104 and, once again when compared to FIG. 4A, this pressure is larger when the membranes 206 are expanded as is the case in FIG. 4B. Accordingly, the compression of the leg of the patient 104 is greater in FIG. 4B then in FIG. 4A. An arrow 406 shown in FIG. 4B represents a circumferential force that also develops from the hoop stress band 202 as the membranes 206 expand.

In the embodiment of FIGS. 4A and 4B, the bladder system 204 (see FIG. 2) includes the number of membranes 206 that are disposed on the inner side of the hoop stress band 202. The fluid reservoir 214 and pump 208 are disposed on the outer side of the band. The membranes 206 and reservoir 214 may be attached to the hoop stress band 202 with heat seals, solvent welding, or through mechanical seals or other suitable techniques such that incompressible fluid cannot leak out of the closed bladder system 204 and reservoir 214. The membranes 206 can be arranged on the hoop stress band in different ways, and can be arranged to localize compressive pressure on a section of a limb, such as on the center of the calf muscle. Furthermore, multiple membranes 206 may be spaced apart on the hoop stress band 202 to prevent pinching of the patient extremity that is under compression. In some embodiments, the bladder system 204, which includes the membranes 206, has a total thickness of less than two inches. In other embodiments, the bladder system 204 has a total thickness of less than one inch and in still other embodiments the bladder system has a total thickness less than half an inch. The low profile of the bladder system 204 allows the compression device 102 to have a low overall profile such that the device may be discretely worn under clothing.

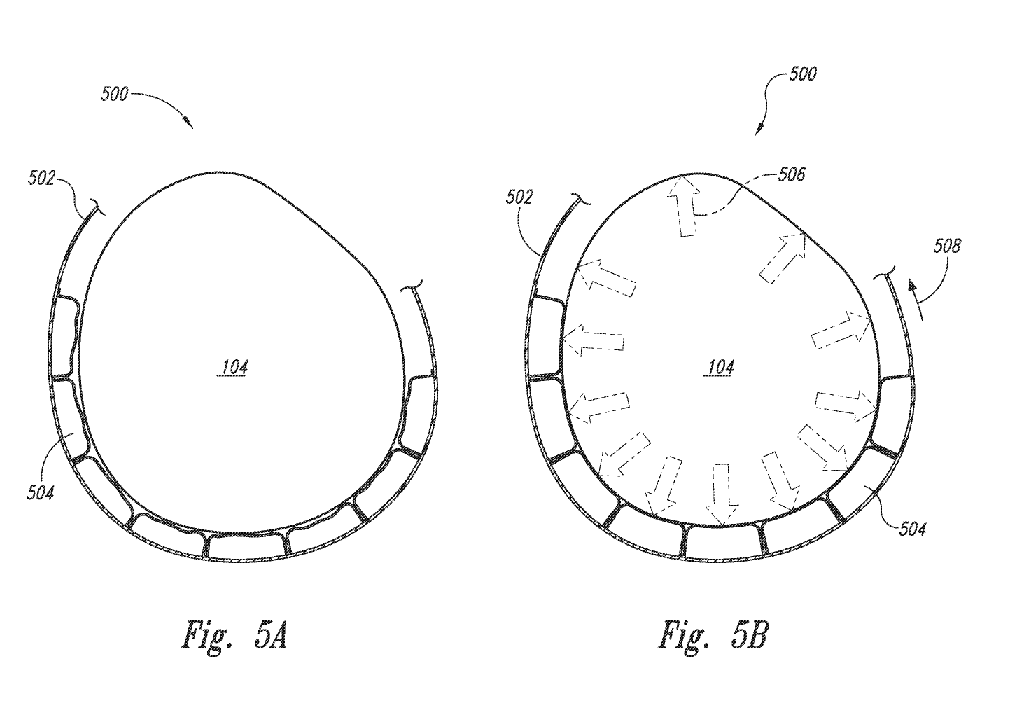

FIGS. 5A and 5B are cross-sectional views of portions of a cuff 500 according to another embodiment of the present invention. The cuff 500 includes a hoop stress band 502 having an integral pump (not shown) and porting assembly (not shown) for distributing fluid to the membranes 504. In this embodiment the pump, porting assembly and the membranes 504 are integral parts of the hoop stress band 502. The cuff 500 operates in the same way as the previously described cuff 200 to compress the leg of the patient 104. FIG. 5B shows an arrow representing a radial outward pressure 506 from the leg of the patient 104 and a circumferential pressure 508 on the hoop stress band that results when the membranes 504 expand due to fluid being pumped into the membranes. Once again, in FIG. 5A the membranes 504 are shown contracted and in FIG. 5B the membranes are expanded due to the pump having pumped fluid in them via the porting assembly. So in this embodiment the bladder system including the membranes 504 and the fluid reservoir (not shown) are be integrated with the hoop stress band 502 and form a buckling system wherein the transfer of fluid from one portion of the bladder system to another results in the pulling or release of the hoop stress band. The hoop stress band may also include a snap latch or a tensioning bar that joins ends of the hoop stress band 502.

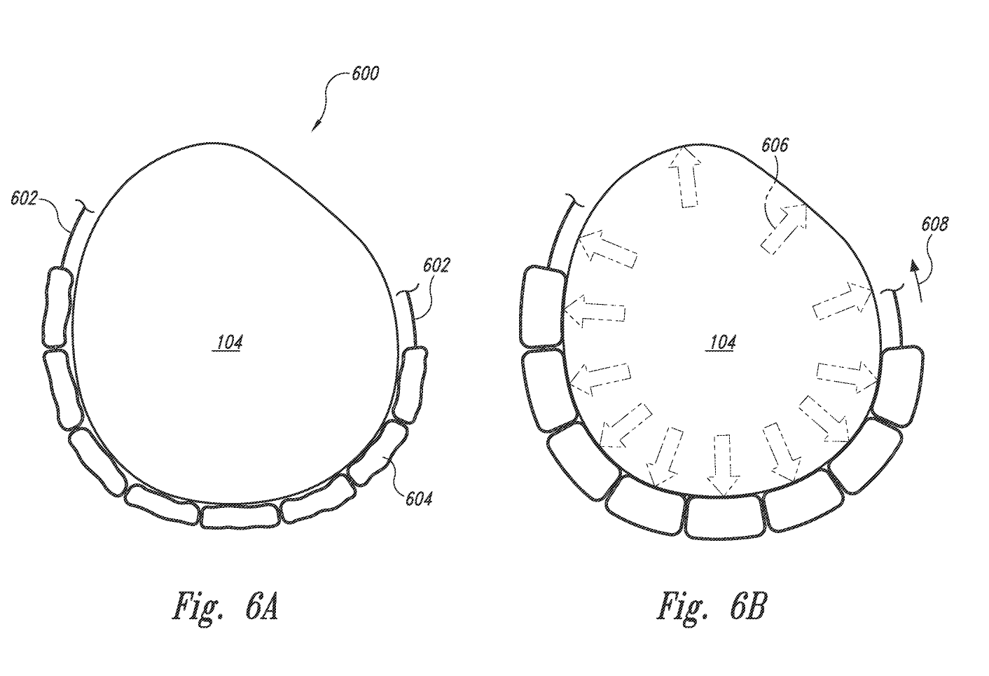

FIGS. 6A and 6B are cross-sectional views of another embodiment of a cuff 600 for use in the compression devices 102 of FIGS. 1 and 2. In this embodiment, the cuff 600 includes a hoop stress band 602 connected at the ends of a series of interconnected chambers 604. The cuff 600 includes a reservoir (not shown) that contains a compressible or incompressible fluid, as is the case for the fluid in the previously described embodiments. The reservoir may be internal or external to the cuff 600 and associated compression device. The chambers 604 are configured such that when the chambers are filled with fluid, the expansion of the chambers exerts a compressive stress on the extremity as illustrate in FIG. 6B. A radial force from the leg of the patient 104 is shown as an arrow 606 in FIG. 6B and a circumferential force on the hoop stress band 602 is represented by arrow 602. As in previously described embodiments, this embodiment may include a porting assembly including a manifold to more evenly inflate or expand the chambers 602. Alternatively, however, the cuff 600 and all previously described embodiments need not include any manifold but instead may include a porting system to individually and independently transfer fluid to and from each chamber 604 or membranes. This would allow the bladder system to achieve more varied compression profiles through differences among the pressures applied by the respective chambers 604 or membranes.

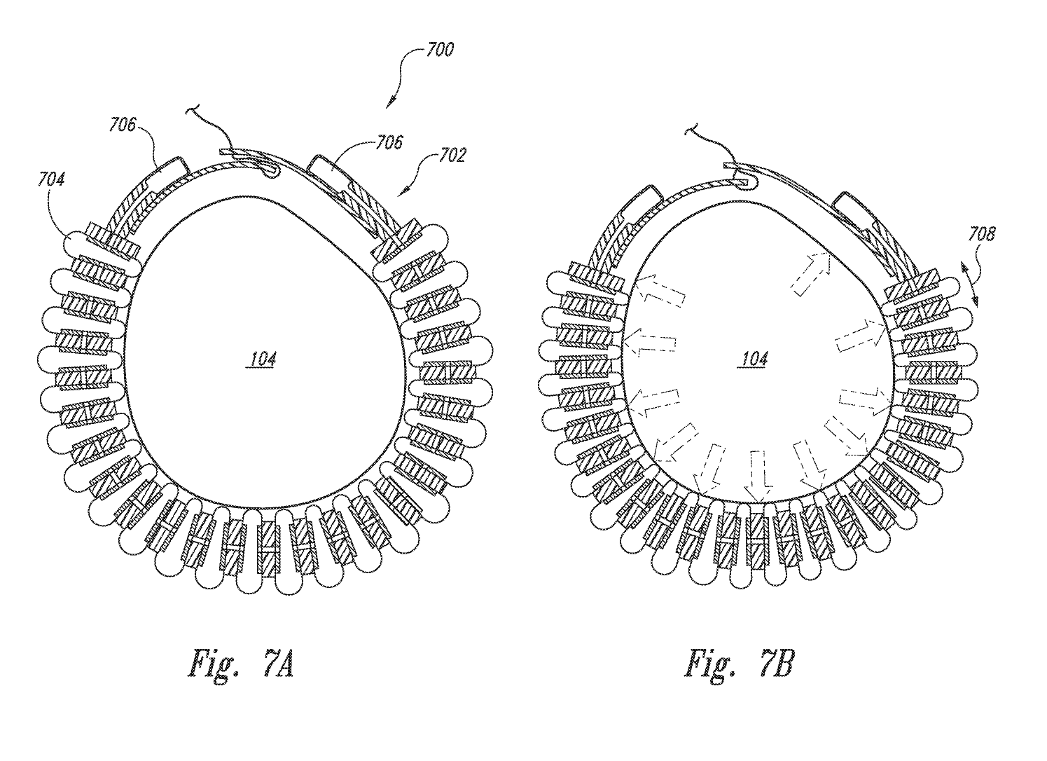

FIGS. 7A and 7B are cross-sectional views showing yet another embodiment of a cuff 700 for use in the compression devices 102 of FIGS. 1 and 2. The cuff 700 includes a hoop stress band 702 formed by a plurality of bellows 704 configured to wraparound the leg or other extremity of the patient 104. A pump 706 is coupled through an appropriate porting assembly (not shown in detail in FIGS. 7A and 7B) to the bellows 704 and operates to develop a vacuum pressure within the bellows. The bellows 704 are formed from a suitable semi-rigid and elastic material, resulting in the bellows constricting and expanding depending upon the level of the vacuum developed by the pump 706. In response to the construction and expansion of the bellows 704, the cuff 700 variable compression to the leg of the patient 104. For example, FIG. 7A shows the bellows 704 where the vacuum within the bellows generated by the pump 706 is less than the pressure of the vacuum within the bellows generated by the pump in FIG. 7B. This is seen in comparing FIG. 7A to FIG. 7B and noting in the latter figure the bellows 704 have constricted in a circumferential direction as indicated by arrow 708 such that the overall circumference of the cuff 700 is smaller in FIG. 7B then in FIG. 7A. As a result, the pressure the cuff 700 applies to the leg of the patient 104 in FIG. 7B is greater than the pressure the cuff applies to the leg in FIG. 7A.

In the embodiments of the cuff 700 illustrated in FIGS. 7A and 7B, the hoop stress band 702 includes segments that hold the bellows 704 together. In other embodiments of the cuff 700 the bellows 704 are constructed such that each individual bellow can be attached, such as through snapping or other coupling, and locked together. In this embodiment, the required number of bellows 704 may then be utilized and thereby allow the cuff 700 to be easily scaled for different body sizes. In one embodiment of the cuff 700, the pump 706 develops a low level of vacuum between 0.5 and 1.0 atmosphere that is sufficient to apply a maximum desired differential pressure of 120 mm Hg on the limb or extremity of the patient 104. The cuff 700 also includes, in one embodiment, integral one-way pressure relief valves and/or bleed ports (not shown) for increased safety of operation. Also, in the illustrated embodiment of FIGS. 7A and 7B the pump 706 is integrated along with the bellows 704 to form an integrated hoop stress band 702 including the bellows. As mentioned above for other embodiments, some embodiments the cuff 700 include porting assemblies and manifolds to provide a more uniform developed vacuum in all the bellows 704.

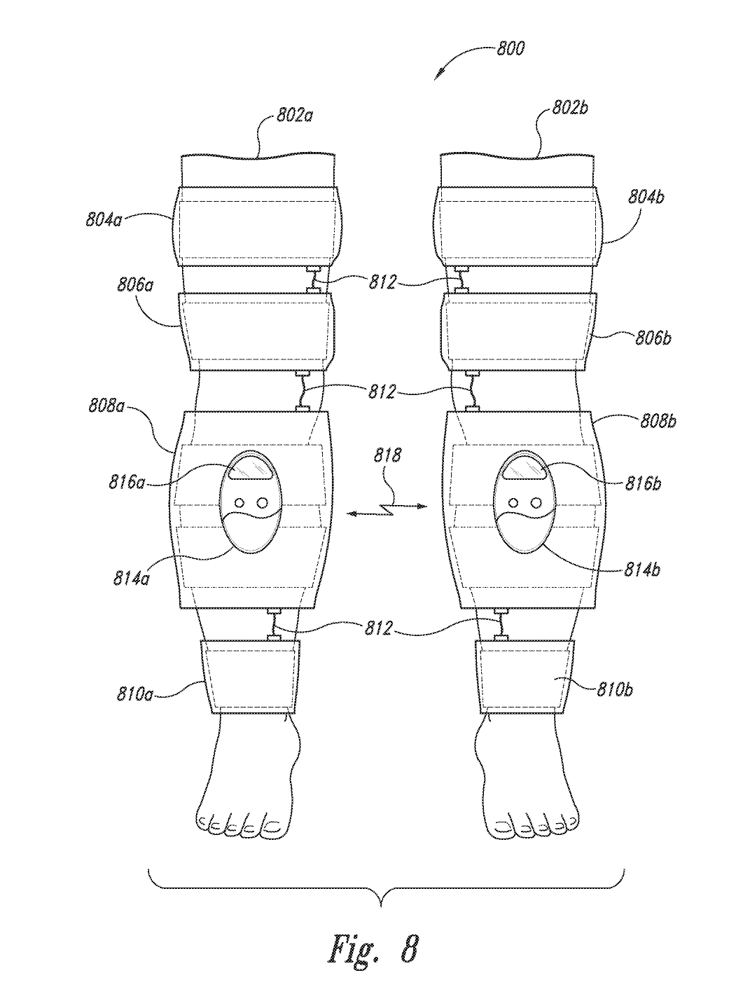

FIG. 8 is a diagram of a compression system 800 on the legs 802 of a patient in which the compression system includes multiple interconnected compression devices 804-810 on each leg according to another embodiment of the present invention. In this embodiment, the illustrated left leg is designated 802a and the right leg 802b. The left leg 802a includes four compression devices 804a-810a that are series connected from the top/thigh to the bottom/ankle of the left leg. Similarly, the right leg 802b includes four compression devices 804b-810b series connected from the top/thigh to the bottom/ankle of the right leg. The compression devices 804-810 of each leg 802 are series connected through wires 812 as shown. In the embodiment of FIG. 8, the compression devices 808a functions for the left leg 802a as a master device, controlling and coordinating the operation of the other series-connected compression devices 804a, 806a and 810a. The compression device 808a includes a control unit 814a having an operator interface including a display 816a that allows the user to control the operation of the compression devices 804a-810a. The compression device 808b similarly includes a control unit 814b having a display 816b and functions in the same way for the series-connected compression devices 804b-810b of the right leg 802b. In the illustrated embodiment of FIG. 8, each of the compression devices 804-810 includes a corresponding cuff, such as the cuff 200 previously described with reference to FIGS. 2 and 3 as well as any of the cuffs described in the following description with reference to subsequent figures. The cuffs for each compression device 804-810 are represented through the corresponding dotted lines shown in FIG. 8. Thus, each of the compression devices 804-800 and is operable to apply compression to the portion of the patient's leg 802 over which that particular compression device is positioned.

In operation, the control units 814a and 814b operate to control the other compression devices 804, 806 and 810 to apply in overall desired compression profile each of the patient's legs 802a and 802b. The user may initiate operation of the compression devices 804-810 to apply the desired compression profile using the display 816 and control unit 814 in the compression devices 808. Once activated to implement the desired compression profile, the control unit 814 in each compression device 808 provides control signals to the other compression devices 804, 806 and 810 to control the cuffs in each of those compression devices to apply the desired compression profile. In response to these control signals, the cuffs in each of the compression devices 804-810 apply the desired compression profile to that portion of the patient's leg 802. For example, where the cuffs in the compression devices 804-810 correspond to the cuff 200 in FIG. 3, in each of the compression devices the corresponding pump 208 operates responsive to the supplied control signals to transfer fluid to and from the fluid reservoir 214 and membranes 206 through the manifold 302 to thereby apply the desired compression profile to the corresponding portion of the patient's leg 802. In addition to control signals from the control units 814, the wires 812 may also communicate data to and from the control unit 814 to the compression devices 804, 806 and 810. Through a communications link 818 the control unit 814a and control unit 814b may wirelessly communicate to coordinate the compression profiles being applied to the left leg 802a and right leg 802b.

Although the compression system 800 is described as including only a single control unit 814a in the compression device 808a for the left leg 802a, and the same for control unit 814b in compression device 808b for the right leg 802b, in other embodiments the cuff in each compression device 804-810 includes a separate control unit 814, but only one of the control units coordinates overall the control of all the cuffs. In this embodiment, appropriate wires 812 connect the master control unit 814 in compression device 808 to the control units in the other compression devices 804, 806, and 810. In this embodiment, as an alternative to the wires 812 the control units 814 in each of the compression devices 804, 806 and 810 could wirelessly communicate with the master control unit 814 in compression device 808. Power transmission signaling for the control units 814 in compression devices 804, 806 and 810 in such an embodiment may be achieved with inductive coupling devices, as will be appreciated by those skilled in the art. Also in this embodiment, the master control unit 814 in compression devices 808 can alter operation of the various cuffs based on sensor system data or valve system data monitored by the control units in the cuffs in compression devices 804, 806 and 810.

In the compression system 800, the master control unit 814 in compression devices 808 coordinates the operation of the cuffs in the other compression devices 804, 806 and 810 to achieve desired compression profiles to meet therapeutic or diagnostic patient needs. Operation of the compression system 800 can be initiated by the patient via the master control units 814 in compression devices 808, and can also be initiated by a physician using a remote user interface, such as the computer system 116 FIG. 1. During operation, the master control unit 814 can adjust operation of the cuffs in the compression devices 804-810 based on sensor data or valve data provided by control units in the cuff in each compression device. The one or more control units 814 in the compression devices 804-810 would typically be battery operated, and may also in some embodiments be structured so as to be removably attached to the associated cuffs of the compression devices and in this way the cuffs and other components of each compression device may be disposable.

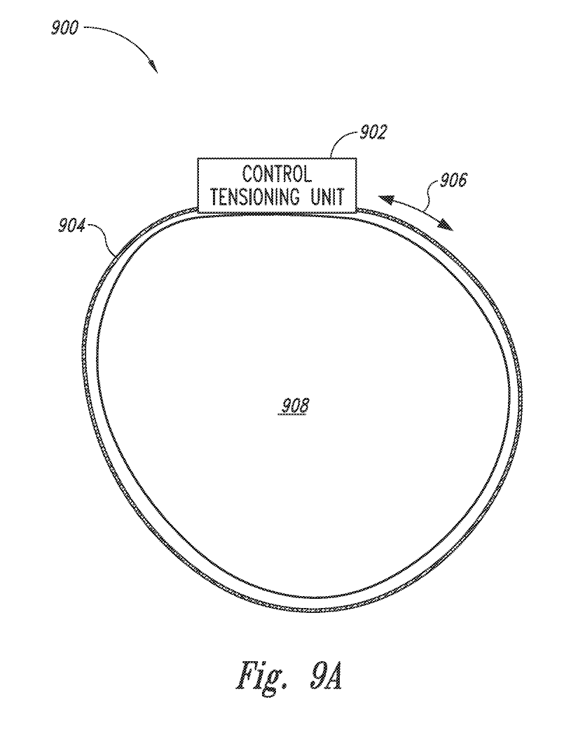

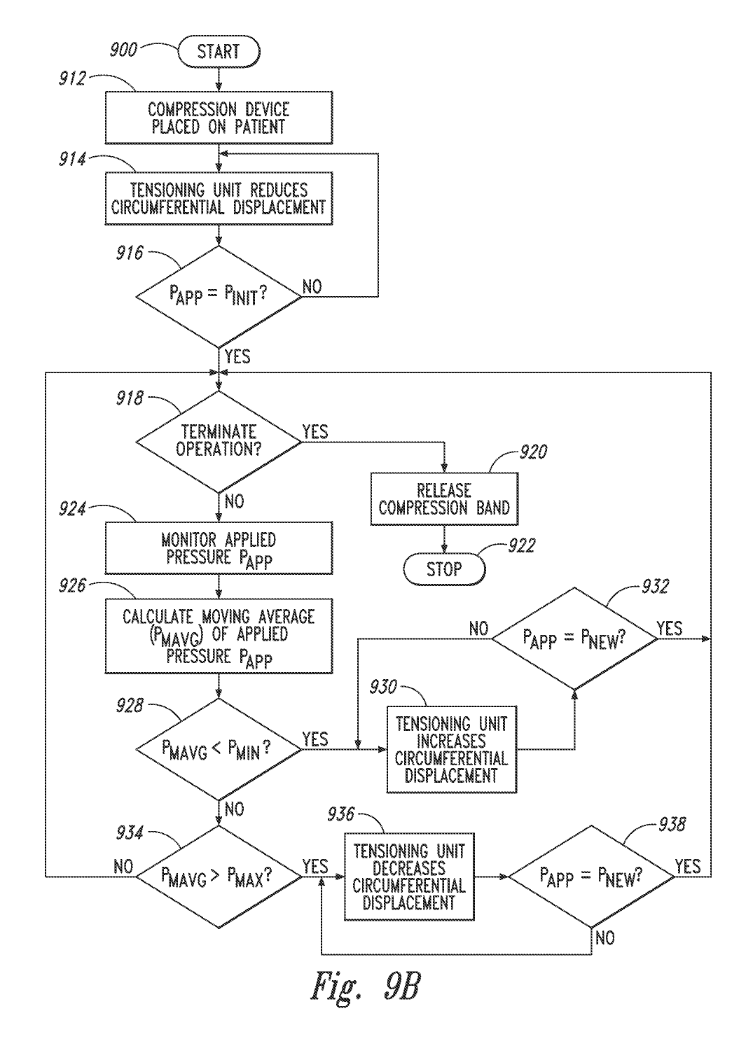

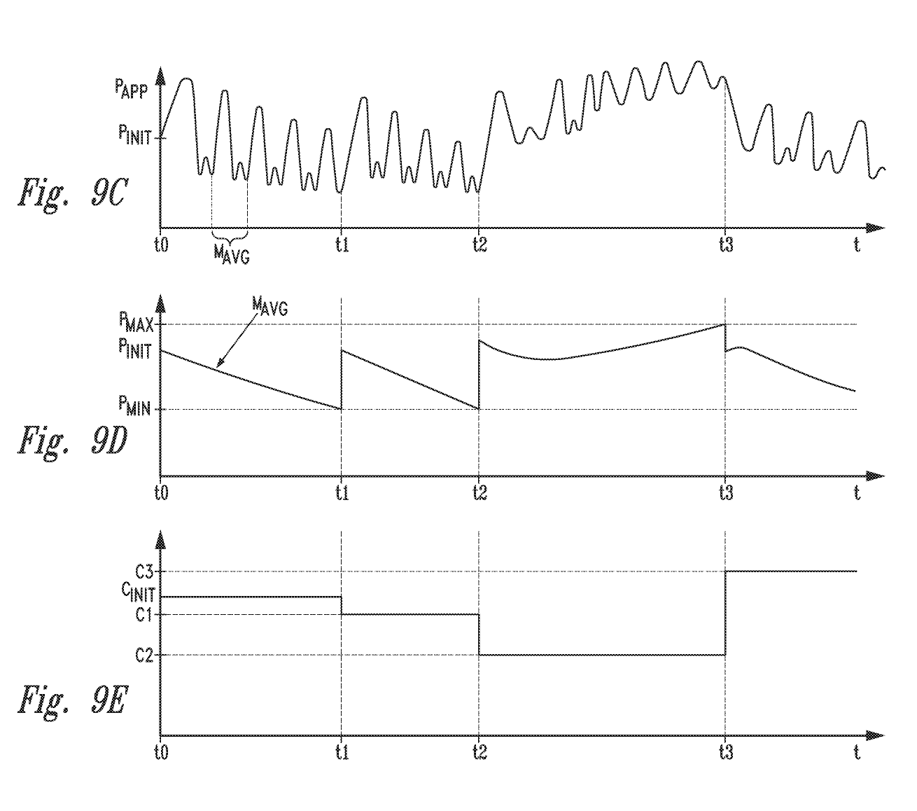

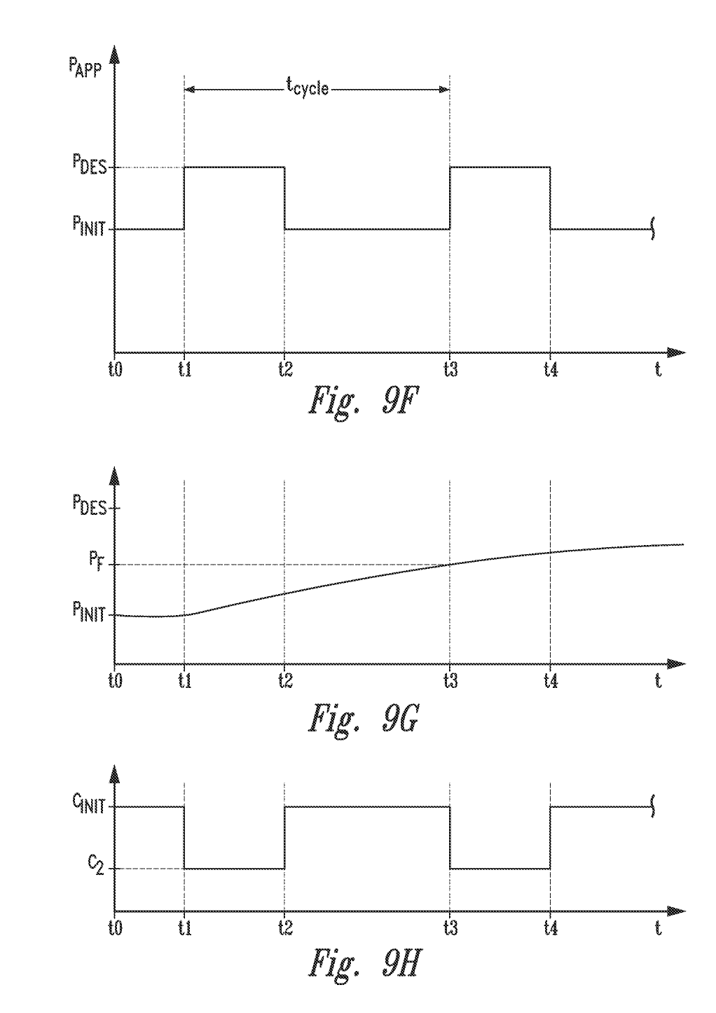

FIG. 9A is a cross-sectional view of a controlled inelastic compression device 900 according to another embodiment of the present invention. The controlled inelastic compression device 900 includes a control and tensioning unit 902 and a compression band 904 that is circumferentially displaced 906 by the control and tensioning unit when the compression band is placed around an extremity 908 of a patient. The compression band 904 is formed from a suitably inelastic material such that the band applies inelastic compression to the extremity 908. As will be appreciated by those skilled in the art, the term “inelastic compression” is used herein to mean that the ability of the compression band 904 to increase in length or circumference in proportion to the applied force is minimal. As a result, the force and pressure the inelastic compression band 904 applies to an extremity is greater than that of an elastic band whose length or circumference more easily increases. This is true generally and particularly when the muscles in the extremity contract.

In operation, the control and tensioning unit 902 controls the circumferential displacement 906 of the compression band 904 to thereby apply a desired compression profile to the extremity 908 of the patient, as will be now explained in more detail below with reference to FIGS. 9B-9F. The circumferential displacement 906 corresponds to changes in the length or circumference of the compression band 904 around the extremity 908 of the patient. The terms circumference and circumferential displacement 906 are utilized to describe the length of compression band 904 and changes in this length, respectively, even though the shape of the compression band when around the extremity 908 may not be precisely that of a circle. The shape will typically be circular, however, and thus this length is referred to as a circumference and changes in the length as circumferential displacement 906. Moreover, the term circumference more accurately reflects the fact that it is the length of the compression band 904 that is actually positioned around the extremity 908 to apply pressure the extremity that is the length that is of interest and that is controlled by the control and tensioning unit 902. In other words, the compression band 904 has some overall length that is fixed, but it is the portion of this overall length that is actually placed around and that applies pressure to the extremity 903 that corresponds to the circumference that is referred to in the present description.

FIG. 9B is a flowchart illustrating one embodiment of a control process executed by the compression device 900 of FIG. 9A in applying a controlled compression profile to an extremity 908 of a patient. This process will be described with reference to the flowchart of FIG. 9B as well as to the graph illustrated in FIG. 9C, which is a graph illustrating an example of a compression profile applied to the extremity of an ambulatory patient during the process of FIG. 9B. The process begins in step 910 and proceeds immediately to step 912 in which the compression device 900 is placed on the extremity 908 of the patient. As mentioned above with reference to the compression device 102 of FIG. 2, the compression device 900 may be slipped over the extremity 908 or included a suitable attachment mechanism allowing the compression band 904 to be opened and then placed over the extremity, as will be described in more detail below.

Once the compression device 900 is placed on the extremity 908 of the patient, the process proceeds to step 914 and the control and tensioning unit 902 is activated. When activated, the control and tensioning unit 902 operates to control the circumferential displacement of the compression band 904 so that an applied pressure P_{APP} applied by the band to the extremity 908 increase towards a desired initial pressure P_{INIT}. In doing so the specific manner in which the control and tensioning unit 902 controls the circumferential displacement to increase the applied pressure P_{APP} may vary, as will be appreciated by those skilled in the art. For example, the control and tensioning unit 902 stepwise increases the circumferential displacement as a function of time in one embodiment and linearly increases the circumferential displacement as a function of time in another embodiment.

From step 914, the process goes to step 916 and determines whether the applied pressure P_{APP} applied by the compression band 904 to the extremity 908 has reached the desired initial pressure PINT. As long as this is not the case, meaning the determination in step 916 negative, the process goes back to step 914 and the control and tensioning unit 902 continues increasing the circumferential displacement so that the applied pressure P_{APP} continues increasing towards the desired initial pressure P_{INIT}. When the applied pressure P_{APP} has reached the desired initial pressure P_{INIT}, the determination in step 916 is positive. The control and tensioning unit 902 then maintains the circumference of the compression band 904 at the corresponding value and the process proceeds to step 918 and determines whether to continue or terminate operation in response to patient or user input. For example, a user such as a physician may wish to reposition the compression device 900 on the extremity 908 of the patient or the patient may wish to remove the compression device in order to take a bath or go swimming.

When the determination in step 918 is positive, meaning that for whatever reason either a user or the patient wishes to terminate use of the compression device 900, the process goes to step 920 and the control and tensioning the 902 releases the compression band 904. Release of the compression band 904 allows the circumference of the band to increase due to outward pressure from the extremity 908 on the band. The applied pressure P_{APP} accordingly decreases, allowing the compression device 900 to be removed from or repositioned on the extremity 908 of the patient. The process then goes to step 922 and terminates.

When the determination in step 918 is negative, operation of the compression device 900 is to continue in the process proceeds to step 924 and monitors the applied pressure P_{APP} applied to the extremity 908 of the patient. This monitoring includes sensing or detecting the value of the applied pressure P_{APP}, and would typically include sampling through appropriate electronic circuitry electrical signals indicating the value of the applied pressure P_{APP} that the compression band 904 is applying to the extremity 908 of the ambulatory patient. Where the compression device 900 is placed around a lower extremity 908 of the patient, the applied pressure P_{APP} will vary due to contraction and release of the patient's muscles in the extremity while moving. Thus, the control and tensioning unit 902 maintains the circumference of the compression band 904 at a constant value and this results in a variable pressure being applied to the extremity 908 of the ambulatory patient. In step 924 the control and tensioning unit 902 samples and stores the values of this variable pressure over time.

From step 924 the process then proceeds to step 926 and utilizes groups of the stored values to determine a moving average of the applied pressure P_{APP} the compression band 904 applies to the extremity 908 of the patient, with this moving average pressure being designated P_{MAVG}. One skilled in the art will understand the concept of a moving average and thus the details of this operation will not be described. Briefly, a subset consisting of a defined number of samples of the applied pressure P_{APP} is utilized to generate a given value for the moving average pressure P_{MAVG}, with new samples being included in the calculation of the moving average pressure as they are acquired and as each new sample is included in the group the oldest P_{APP} sample is removed.

The process then proceeds from step 926 to step 928 and determines whether the moving average pressure P_{MAVG} is less than a minimum pressure P_{MIN}. The minimum pressure P_{MIN} to ensure that the compression profile corresponding to the applied pressure P_{APP} as desired characteristics for proper treatment of the patient. For example, when the compression device 900 is being utilized to treat chronic venous insufficiency (CVI), as the circumference of the compression band 904 is maintained, constant fluid in the extremity 908 of the patient is removed due to the corresponding applied pressure P_{APP}. This applied pressure P_{APP} will ideally decrease over time as the fluid is removed. Thus, to continue removing additional fluid from the extremity, and to physically maintain the compression band 904 in position on the extremity 908, the moving average pressure P_{MAVG} of the applied pressure P_{APP} is maintained above a minimum pressure P_{MIN}.

When the determination in step 928 is positive this means that the moving average pressure P_{MAVG} has dropped below the desired minimum pressure P_{MIN}. The control and tensioning unit 902 then controls the circumferential displacement of the compression band 904 to increase the applied pressure P_{APP}. Accordingly, the process goes to step 930 and the control and tensioning unit 902 increases the circumferential displacement of the compression band 904, meaning that the control and tensioning unit reduces the circumference of or tightens the compression band around the extremity 908. In the present description increasing or decreasing circumferential displacement are utilized relative to an initial position or circumference of the compression band 904. The circumferential displacement is said to be increasing when the circumference of the compression band 904 is decreasing to tighten the band around the extremity 908. Conversely, the circumferential displacement is said to be decreasing when the circumference of the compression band 904 is increasing.

Once the control and tensioning unit 902 has increased the circumferential displacement of the compression band 904 in step 930, the process goes to step 932 and determines whether the applied pressure P_{APP} equals a new desired pressure PNEW. The new pressure PNEW could, for example, be the initial pressure P_{INIT} that was initially developed by the compression band 904 in step 916. When the determination in step 932 is negative the applied pressure P_{APP} has not yet reached the desired new pressure PNEW, and so the process returns to step 930 and the control and tensioning unit 902 increases the circumferential displacement of the compression band 904 to thereby increase the applied pressure P_{APP}. The process continues executing steps 930 and 932 until the determination in step 932 is positive, meaning that the applied pressure P_{APP} has reached the desired new pressure P_{APP}. At this point, the process goes from step 932 back to step 918 and executes as previously described for this step and the following steps 920-928.

Returning now to step 928, when the determination in step 928 is negative this means that the moving average pressure P_{MAVG} is not less than the desired minimum pressure P_{MIN}. Accordingly, the operation of the compression device 900 is satisfactory at this point in that the moving average of the applied pressure P_{APP} (i.e., the P_{MAVG} pressure) being applied by the compression band 904 is above the minimum pressure P_{MIN}. From step 928, the process goes to step 934 and determines whether the moving average pressure P_{MAVG} has exceeded a threshold maximum pressure P_{MAX}.

The compression device 900 performs this determination in step 934 primarily to ensure safety of the patient. For example, if the patient has chronic venous insufficiency and the compression profile being applied by the compression device 900 does not result in fluid being gradually removed from that portion of the patient's extremity 908 over which the compression device is placed then the applied pressure P_{APP} could increase to unsafe levels. For example, if the compression device 900 is operating at a given circumference of the compression band 904 and fluid within the patient's extremity 908 flows back into that portion of the extremity over which the compression device is placed then the applied pressure P_{APP} will increase, perhaps to an unsafe level. Accordingly, the process performs this check on the moving average pressure P_{MAVG} exceeding the threshold maximum pressure P_{MAX} in step 934.

When the determination in step 934 is negative, the moving average pressure P_{MAVG} does not exceed the threshold maximum pressure P_{MAX} meaning that the compression device 900 is operating properly within prescribed thresholds for the moving average pressure P_{MAVG}. Accordingly, if the determination in step 934 is negative the process goes back to step 918 and executes as previously described for this step and the following steps 920-928. If, however, the determination in step 934 is positive then this means the moving average pressure P_{MAVG} has exceeded the threshold maximum pressure P_{MAX} and the process goes to step 936 in which the control and tensioning unit 902 decreases the circumferential displacement of the compression band 904. As previously mentioned, decreasing the circumferential displacement means that the circumference of the compression band 904 is increased, loosening the band around the patient's extremity 908 and thereby lowering the applied pressure P_{APP}.

From step 936 the process then goes to step 938 and determines whether the applied pressure P_{APP} has been decreased to a desired new pressure PNEW. Note, the new pressure PNEW in step 938 need not have the same value as the new pressure in step 932. When the determination in step 938 is positive, the applied pressure P_{APP} equals the desired new pressure PNEW the process goes back to step 918 and executes as previously described for this step and the following steps 920-934. When the determination in step 938 is negative, the process goes back to step 936 and the control and tensioning unit 902 decreases the circumferential displacement to further lower the applied pressure P_{APP}. The process then goes back to step 928 and once again determines whether the applied pressure P_{APP} is less than the new pressure PNEW. The process continues executing steps 936 and 938 until the determination in step 938 is positive and the process then returns to step 918.

In one embodiment, the control and tensioning unit 902 also monitors the overall circumferential displacement of the compression band 904 and terminates operation when the circumferential displacement exceeds some maximum threshold value. For example, a physician or other user may desire that even if operation of the compression device 900 is otherwise proceeding properly the circumference of the compression band 904 should not fall below some minimum value. Thus, the control and tensioning unit 902 monitors the overall increase in the circumferential displacement of the compression band 904 and terminates or otherwise adjusts operation of the compression device 900 when the increase in the circumferential displacement exceeds some maximum value.

FIG. 9C is a graph illustrating an example of the compression profile applied to the extremity of an ambulatory patient during the process of just described FIG. 9B. The compression profile of FIG. 9C shows the applied pressure P_{APP} applied by the compression band 904 to the extremity 908 of the patient's leg as a function of time. FIG. 9D is a graph illustrating the moving average P_{MAVG} of the pressure in the compression profile of FIG. 9C. FIG. 9E is a graph illustrating control of the circumference and circumferential displacement of the compression band of the compression device 900 of FIG. 9A during execution of the process of FIG. 9B.

In the graphs of FIGS. 9C-9E, a time t0 corresponds to step 916 in the process of FIG. 9B when the applied pressure P_{APP} equals the desired initial pressure P_{INIT}. This is seen in FIG. 9D at the time t0 where the moving average pressure P_{MAVG} has the desired initial pressure P_{INIT}. In FIG. 9C the compression band 904 has an initial circumference C_{INIT} at the time t0. After time t0, the ambulatory state of the patient results in variations in the applied pressure P_{APP} as the muscles in the extremity 908 of the ambulatory patient contract and relax as the patient moves. This is seen in FIG. 9A. The initial circumference C of the compression band 904 is designated C_{INIT} in FIG. 9E and corresponds to the initial circumference of the compression band at which the desired initial applied pressure P_{APP} is generated.

From the time interval from time t0 to time t1 the control and tensioning unit 902 holds the circumference of the compression band 904 constant at initial circumference C_{INIT}, as seen in FIG. 9E. During this time interval, the control and tensioning unit 902 samples the applied pressure P_{APP} applied to the extremity 908 as illustrated in FIG. 9C. As previously mentioned, as the control and tensioning unit 902 maintains the circumference C at the initial circumference C_{INIT} and ambulatory patient moves, muscle contraction and relaxation in the extremity result in the variable applied pressure P_{APP} as a function of time shown in FIG. 9C. Note that the waveform for the applied pressure P_{APP} in FIG. 9C is merely an example intended to show the variation of the applied pressure as a function of time and that actual waveforms would likely vary.

During the time interval from t0 to t1 as the applied pressure P_{APP} varies as shown in FIG. 9C, the control and tensioning unit 902 samples this waveform and utilizes the samples to generate values for the moving average pressure P_{MAVG} shown in FIG. 9D. A number of samples of the applied pressure P_{APP} over a sample window MAVG as shown in FIG. 9C are utilized in generating corresponding points on the moving average pressure P_{MAVG} graph of FIG. 9D. This is a sliding moving average MAVG as previously mentioned.

As seen FIG. 9D, in the illustrated graph the moving average pressure P_{MAVG} initially has the value P_{INIT} and then decreases as a function of time during the interval from t0 to t1. In the illustrated example this decrease is shown as being approximately linear although this need not be the case and is illustrated in this way merely for the sake of example. The applied pressure P_{APP} and thus the moving average pressure P_{MAVG} would be expected to trend downward over time generally, however, at least when the compression device 900 is being utilized to treat chronic venous insufficiency. This is true because as the compression profile illustrated in FIG. 9C is applied to the extremity 908 fluid will be removed from the portion of the extremity over which the compression band 904 is placed. As a result, since the circumference of the compression band is maintained at the constant initial circumference C_{INIT} value this removal of fluid results in a gradual reduction in the applied pressure P_{APP}, as manifested in the decreasing moving average pressure P_{MAVG} of FIG. 9D.

Notice that in FIG. 9D two thresholds are indicated in this graph, namely a minimum pressure threshold P_{MIN} and a maximum pressure threshold P_{MAX} which were both previously mentioned above with reference to the description of the flowchart of FIG. 9B. See steps 928 and 934 in this flowchart. As long as the moving average pressure P_{MAVG} remains within the pressure window defined by the thresholds P_{MIN} and P_{MAX}, the compression device 900 operates as described in the process of FIG. 9B to apply the compression profile given by the applied pressure P_{APP} to the extremity 908. This corresponds to the determination in both steps 928 and 934 in the flowchart of FIG. 9B being negative.

At the time t1 the moving average pressure P_{MAVG} reaches the minimum pressure threshold P_{MIN}, corresponding to a positive determination in step 928 of FIG. 9B. The operation of subsequent steps 930 and 932 is then represented in FIG. 9C through a change in the circumferential displacement as illustrated in FIG. 9E at the time t1. More specifically, the control and tensioning unit 902 increases the circumferential displacement of the compression band 904 at the time t1, meaning the circumference C of the compression band decreases. This is seen in FIG. 9E as a decrease in the circumference C of the compression band 904 at the time t1 from the initial circumference C_{INIT} to a new circumference designated C₁. As seen in FIG. 9E the new circumference C₁ is smaller than the initial circumference C_{INIT} such that the applied pressure P_{APP} the compression band 904 applies to the extremity 908 increases, as illustrated in FIG. 9C. This is represented in the graph of FIG. 9D as the moving average compression P_{MAVG} increasing as shown such that this moving average pressure is once again within the compression window defined by the thresholds P_{MIN} and P_{MAX}.

A second time interval from the time t1 until a time t2 demonstrates similar operation of the compression device 900. Once again at the end of this time interval, namely at the time t2, the moving average compression P_{MAVG} reaches the minimum pressure threshold P_{MIN} and the control and tensioning unit 902 increases the circumferential displacement to thereby decrease the circumference C of the compression band 904 to the circumference C₂ as illustrated in FIG. 9E. This once again results in the applied pressure P_{APP} and the moving average pressure P_{MAVG} increasing as illustrated in FIGS. 9C and 9D, respectively, as shown.

A third time interval from the time t2 until a time t3 is also illustrated in FIGS. 9C-9E. This time interval illustrates the operation of the compression device that occurs in steps 934-938 in the flowchart of FIG. 9B when the moving average pressure P_{MAVG} reaches the maximum pressure threshold P_{MAX}. In this situation the applied pressure P_{APP} and thereby the moving average pressure P_{MAVG} need to be lowered, so in this situation the control and tensioning unit decreases the circumferential displacement as illustrated in FIG. 9E at the time t3. As a result, the circumference of the compression band 904 increases to a circumference C₃ as shown in FIG. 9E. This increased circumference C₃ results in the applied pressure P_{APP} and the moving average pressure decreasing as illustrated in FIGS. 9C and 9D at the time t3. Once again, the moving average pressure P_{MAVG} is adjusted, decreased in this situation, so that it falls within the desired pressure window defined by the thresholds P_{MIN} and P_{MAX}.

FIG. 9F is a graph illustrating an example of a compression profile applied to the extremity 908 of a non-ambulatory patient by the compression device 900 of FIG. 9A. In this situation, the patient is stationary and so the variations illustrated in the compression profile of the applied pressure P_{APP} of FIG. 9C are not present, or are present to a much lesser extent. As a result, once the control and tensioning unit 902 has set the circumference C at the initial circumference C_{INIT} to apply the desired initial pressure P_{INIT}, the control and tensioning unit thereafter controls the circumferential displacement of the compression band 904 to thereby apply cyclic or intermittent desired pressure P_{DES} to the extremity 908. This is seen in FIGS. 9G and 9H. FIG. 9H illustrates the control of the circumference C and circumferential displacement the control and tensioning unit 902 uses to generate the non-ambulatory compression profile of FIG. 9F in one embodiment. FIG. 9G is a graph illustrating the moving average pressure P_{MAVG} resulting from the compression profile of FIG. 9F.

The non-ambulatory process illustrated in FIGS. 9F-9H and executed by the compression device 900 is now described in more detail with reference to these figures. The compression device 900 operates as previously described to establish and initial circumference C_{INIT} as shown in FIG. 9H and initial applied pressure P_{INIT} as shown in FIG. 9F. The control and tensioning unit 902 and thereafter maintain the circumference C of the compression band 904 at the initial circumference C_{INIT} until a time t1. Thus, up until the time t1 the compression band 904 applies the initial pressure P_{INIT} to the extremity 908 of the patient. At the time t1, the control and tensioning unit 902 increases the circumferential displacement of the compression band 904, thereby reducing the circumference C of the band from the initial circumference C_{INIT} to a second circumference C₂ as shown in FIG. 9H.

In response to the second circumference C₂ of the compression band 904, the compression band applies a new desired pressure P_{DES} that is greater than the initial pressure P_{INIT} as seen in FIG. 9F at the time t1. The control and tensioning unit 902 maintains the circumference C of the compression band 904 at the second circumference C₂ until a time t2, at which point the control and tensioning unit decreases the circumferential displacement of the compression band such that the compression band returns to the initial circumference C_{INIT}. As a result, as seen in FIG. 9F at time t2 the applied pressure P_{APP} decreases to the initial applied pressure P_{INIT}. The control and tensioning unit 902 maintains the compression band 904 at the initial circumference C_{INIT} from the time t2 until a time t3. The time interval from the time t1 to the time t3 defines a cycle time t_{cycle} of the compression device 900 during the non-ambulatory mode of operation. Accordingly, at time t3 the control and tensioning device 902 controls the circumference C of the compression band 904 in the same way as just described for the interval from time t1-t3. The control and tensioning unit 902 continues operating in this manner in the non-ambulatory mode until such operation is terminated. As a result, as seen in FIG. 9G the moving average pressure P_{MAVG} increases to a final moving average pressure PF. The value of the final moving average pressure PF is a function of the duty cycle of the applied pressure P_{APP} and thus of the circumferential displacement of the compression band 904. The duty cycle corresponds to the portion of the cycle time t_{cycle} for which the higher desired pressure P_{DES} is applied divided by the cycle time t_{cycle}. Thus, in this embodiment the final moving average pressure PF is given by PF=((t2−t1)/tcycle))×P_{DES}. In other embodiments of the non-ambulatory process implemented by the control and tensioning unit 902, the control and tensioning unit controls the circumferential displacement in different ways to achieve the desired compression profile corresponding to the applied pressure of FIG. 9F and to thereby achieve the desired final moving average pressure PF.

As was previously described for the compression devices 102 of FIGS. 1-3 and which is also true of the compression devices 804-810 of FIG. 8, the controlled inelastic compression device 900 can operate in a variety of different ways and in response to a variety of different sensed parameters to apply the desired compression profile to the extremity of the patient. The processes described with reference to FIGS. 9B-9H are merely examples of how the controlled inelastic compression of the device 900 can be utilized to apply a desired compression profile to an extremity of a patient. In other embodiments, control circuitry (not shown) in the control and tensioning unit 902 can include inertial sensors that sense movement of the patient such that the compression profile provided by the compression device 900 can be altered as a function of the ambulatory state of the patient. The control circuitry could also sense various vital signs of the patient such as heart rate, breathing rate, temperature of the patient's extremity, applied pressure to the extremity, and so on to achieve the desired compression profile and increase the likelihood of successful treatment using the compression device 900. Also, although the moving average of the applied pressure P_{APP} is used in the embodiment of FIGS. 9A-9H, in other embodiments the control and tensioning unit 902 can control operation of the compression device 900 responsive to instantaneous values of the applied pressure.

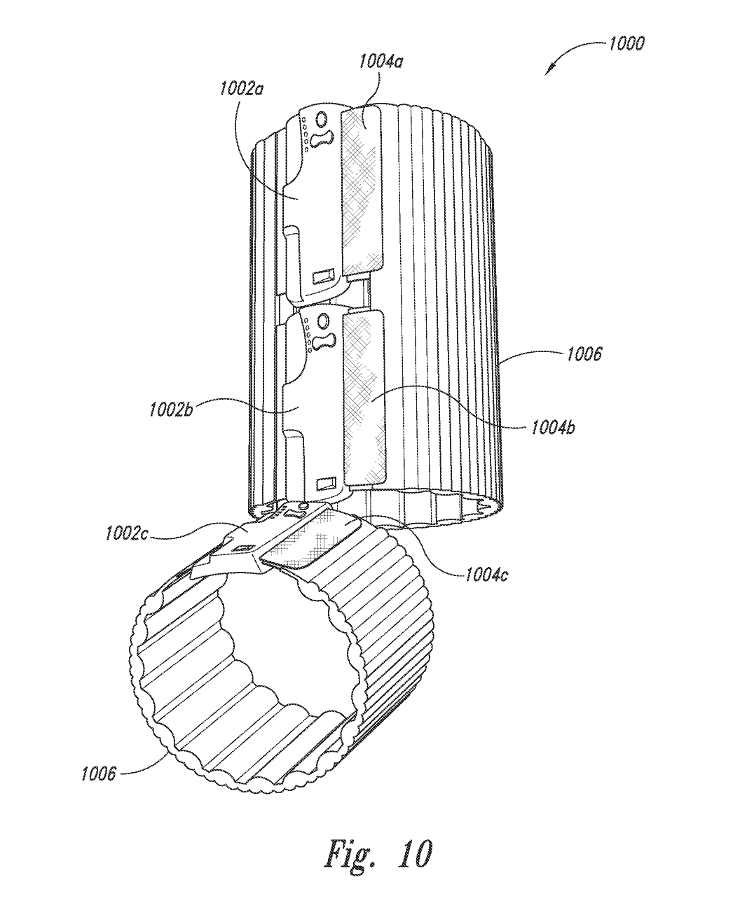

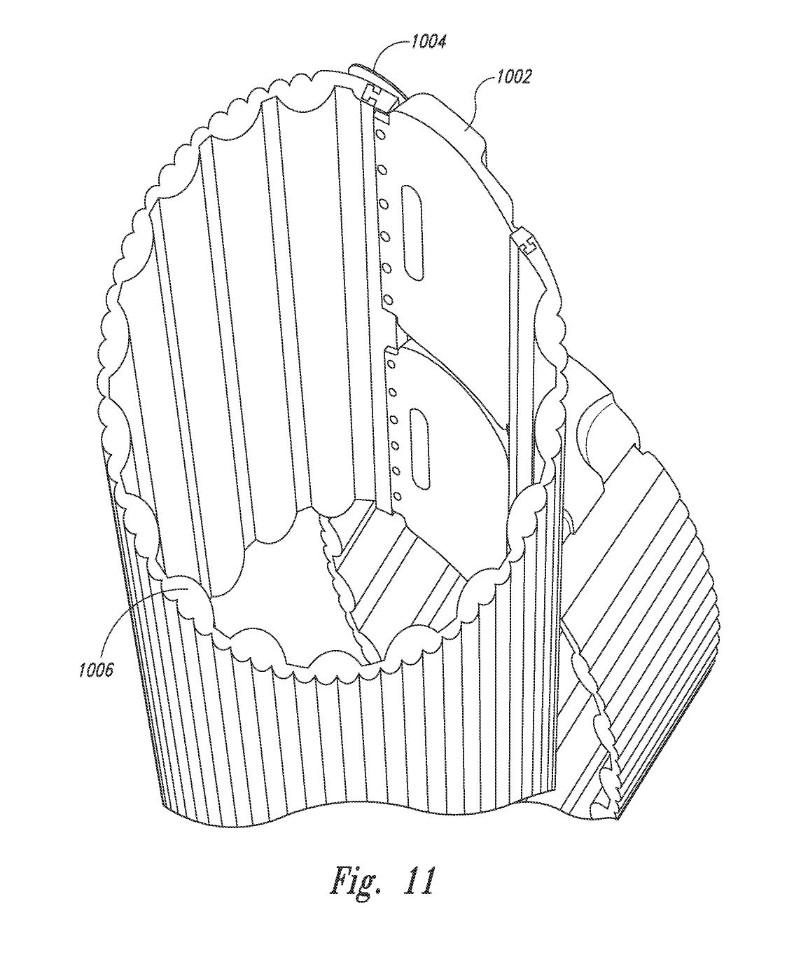

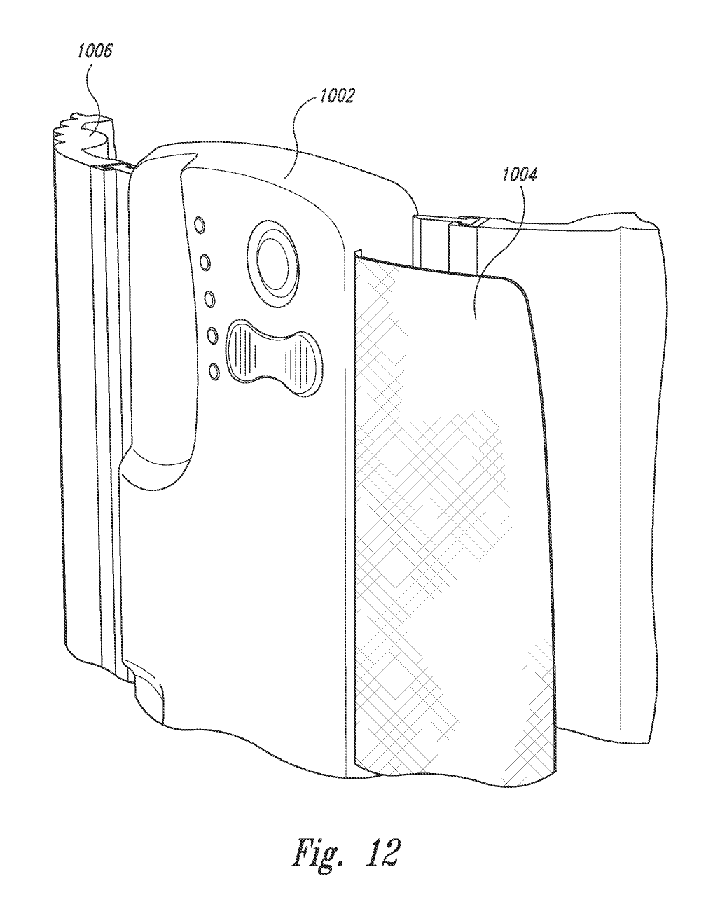

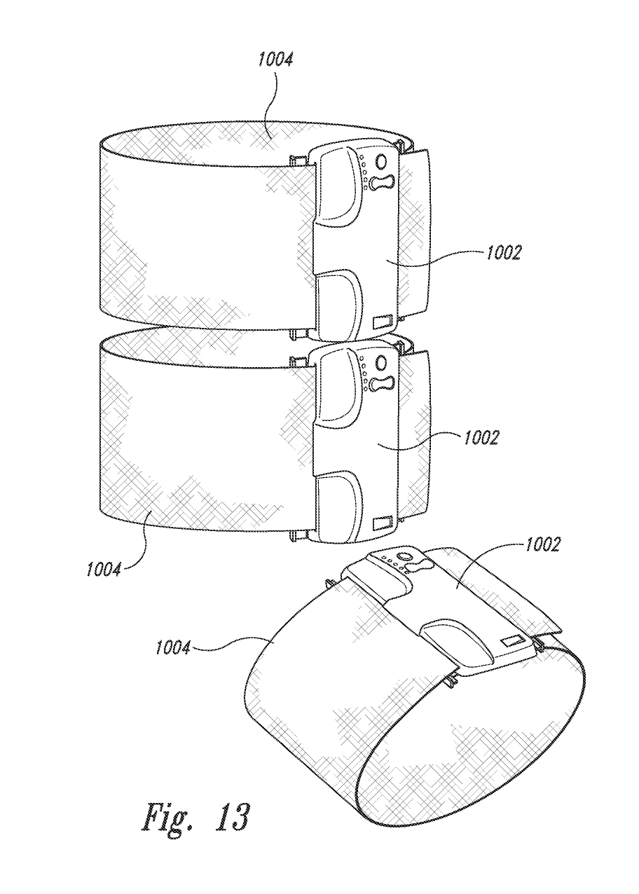

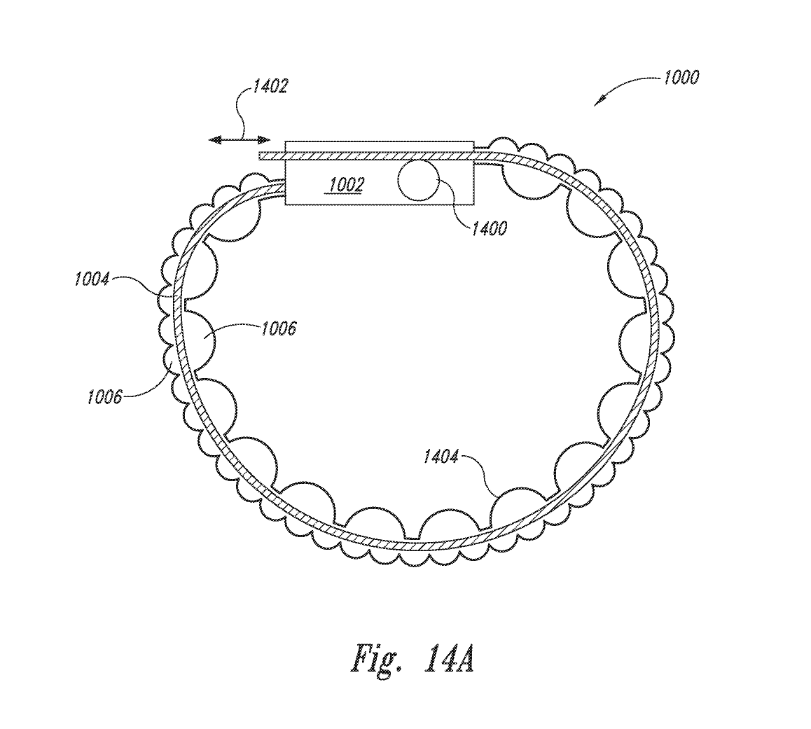

FIG. 10 is a perspective front view illustrating in more detail a controlled inelastic compression device 1000 according to another embodiment of the present invention. The compression device 1000 includes three control and tensioning units 1002a, 1002b, 1002c that are each adapted to receive one end of a corresponding slip compression band 1004a, 1004b, 1004c. In the embodiment of FIG. 10 a fluid-filled outer sleeve 1006 surrounds the slip compression bands 1004 as is better seen in FIG. 11, which is a perspective top view of the controlled inelastic compression device 1000 of FIG. 10. The fluid-filled outer sleeve 1006 includes an arrangement of closed cells containing fluid. The fluid-filled outer sleeve 1006 provides an interface with the patient limb that will translate in a radial direction, therefore preventing discomfort from any form of sliding friction. Furthermore, the fluid-filled outer sleeve 1006 minimizes discomfort from local high pressure zones, as example from possible limb non-uniformities, as the fluid cells locally “give” to uniformly redistribute the pressure to adjacent areas across the given cell. As seen in FIG. 11, the fluid-filled outer sleeve 1006 surrounds the slip compression band 1004 except for an end portion of the slip compression band that fits into the control and tensioning unit 1002. This is better seen in FIG. 12, which is a magnified perspective front view of the controlled inelastic compression device 1000 of FIG. 10 showing the end portion of the slip compression band 1004 inserted through the control and tensioning unit 1004. The opposite end of the slip compression band 1004 is fixedly attached to the control and tensioning unit 1002. As the control and tensioning unit 1002 is operated, one end of the slip compression band 1004 is translated through the control and tensioning unit 1002, hence changing the effective circumference of the slip compression band 1004. As the slip compression band 1004 is translated, it slides within the fluid-filled filled outer sleeve 1006 to prevent the discomfort of sliding motion across a limb. The limb will therefore only experience purely radial translation and associated changes in pressure. In addition, as the controlled inelastic compression device 1000 constricts, the tangential compression of the fluid cells causes them to elongate in a radial direction, therefore adding to the desired effect of radial displacement. FIG. 13 is a perspective front view of the controlled inelastic compression device 1000 of FIG. 10 illustrating the slip compression bands 1004 without the fluid-filled outer sleeves 1006 attached to the slip compression bands.

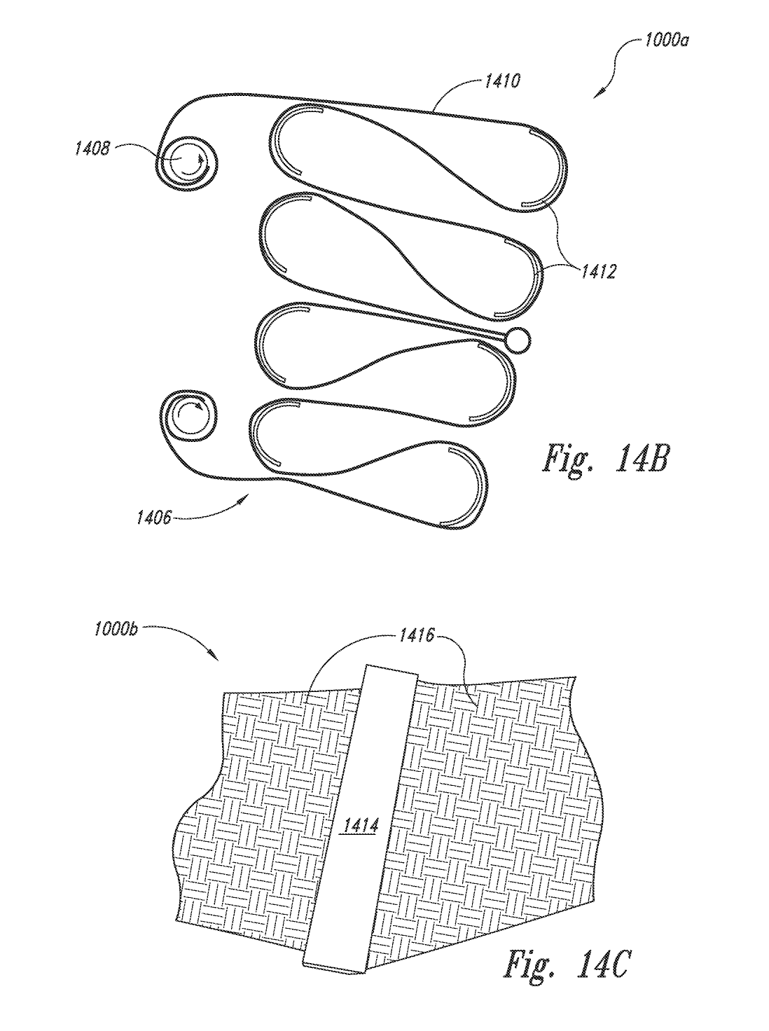

FIG. 14A is a functional cross-sectional view showing the control and tensioning unit 1002, slip compression band 1004, and fluid-filled outer sleeve of the controlled inelastic compression device 1000 of FIG. 10. As seen in FIG. 14A, the slip compression band 1004 is surrounded by the fluid-filled outer sleeve 1006 except for an end portion of the slip compression band that fits into a slit on the right side of the control and tensioning unit 1002 and through this led to extend from the left side of the control and tensioning unit. In one possible embodiment, the inserted end of the slip compression band 1004 is pre-inserted to eliminate the need for the user to feed it properly into the control and tensioning unit 1002. In this case, either the device opens adequately to slip on over the end of the limb or a simple joint is formed on the cuff at another location.

The control and tensioning unit 1002 includes a drive mechanism 1400 that is operable to retain the end portion of the slip compression band 1004 within the control and tensioning unit and to drive the end portion to either the left or right as illustrated by the arrows 1402 in FIG. 14A. The drive mechanism 1400 can have a variety of different suitable structures, as will be appreciated by those skilled in the art. For example, the drive mechanism could include teeth on a rotating element that then fit into corresponding grooves or holes formed in the end portion of the slip compression band 1004. Alternatively, the drive mechanism 1400 could be a suitable friction drive mechanism or elements of the drive mechanism maintain the end portion of the slip compression band 1004 within the control and tensioning unit 1002 through friction between these elements and the end portion of the slip compression band. The motive force for the drive mechanism 1400 could be applied by an electric motor with adequate gear reduction or a fluid pump with a hydrostatic drive system.

In operation, the control and tensioning unit 1002 operates to drive the end portion of the slip compression band 1004 to the left or to the right as illustrated by the arrow 1402. In this way, the control and tensioning unit 1002 controls the tension of the slip compression band 1004 and thereby compression applied by the slip compression band and integrally attached fluid-filled outer sleeve 1006 to the patient extremity around which the compression device 1000 is placed. Fluid cells 1404 in the fluid-filled outer sleeve 1006 in combination with the slip compression band 1004 form a hydrostatic compression system that functions to provide evenly distributed pressure to the patient extremity. The fluid-filled outer sleeve 1006 and fluid cells 1404 distribute the pressure from high pressure points that could otherwise result to imperfections on the extremity around which the device 100 is placed, making the device more comfortable and applying more uniform pressure to the extremity. Note the specific arrangement of the fluid-filled cells 1404 on the fluid-filled outer sleeve 1006 can vary in other embodiments of the compression device 1000. This is also true of the specific arrangement of the membranes 206 in the embodiments of FIGS. 3 and 4 as well as the arrangements of the membranes 504 of FIG. 5, chambers 604 in FIGS. 6, and bellows 704 in FIG. 7.

The control and tensioning unit 1002 can sense a variety of different patient parameters and implement a variety of different control algorithms responsive to the sensed parameters, as previously mentioned with regard to the compression devices 102, 804-810, and 900. For example, the control and tensioning unit 1002 can monitor ambulatory state of the patient and adjust the applied compression profile accordingly. When the patient is walking, for example, the control and tensioning unit 1002 may stop applying a given compression profile to the patients extremity and when the patient is immobile, such as when the patient is sleeping, the control and tensioning unit may reactivate and apply the desired compression profile.

The control and tensioning unit 1002 can also sense pressure, force and temperature of the patient extremity, with temperature possibly being sensed by sensing the temperature of the liquid contained in the fluid cells of the fluid-filled outer sleeve 1006. Temperature could be modulated according to certain control algorithms being implemented by the control and tensioning unit 1002, such as through a Peltier heat transfer system. In addition, the control and tensioning unit 1002 can measure other patient parameters such as leg circumference of the patient, and utilize this measured parameter accordingly. For example, the control and tensioning unit 1002 could monitor leg circumference changes from a given point in time, such as when the patient initially puts on the compression device 1000. The control and tensioning unit 1002 could then take a variety of different actions utilizing the measured leg circumference changes. For example, the control and tensioning unit 1002 could adjust the displacement of the slip compression band to the left or to the right as indicated by arrows 1402 in order to maintain a constant pressure applied to the patient extremity. As an added safety feature, the control and tensioning unit 1002 could limit further displacement once a previously programmed minimum circumference was reached.

FIG. 14B is a functional plan view of a compression device 1000a which is another embodiment of the compression device 900 or 1000 of FIGS. 9A and 10. The compression device 1000a includes, instead of the slip compression band 1004 and fluid-filled outer sleeve 1006, a corset-type compression band 1406 applies the desired compression profile to the extremity around which the corset-type compression band is placed. A control and tensioning unit 1408 controls the applied pressure by controlling a tensioning line 1410 that is alternately wound around curved line guides 1412 as shown. In operation, the corset-type compression band 1406 is wrapped around a patient extremity (not shown) and the control and tensioning unit 1408 tightens and releases the tensioning line 1410 as required to develop the desired compression profile applied to the extremity.

FIG. 14C is a functional plan view of a compression device 1000b according to yet another embodiment of the compression device 900 or 1000 of FIGS. 9A and 10. The compression device 1000b includes a control and tensioning unit 1414 and an open-weave compression band 1416 that is configured to be placed around a patient extremity (not shown). In operation, the open-weave compression band 1416 is wrapped around a patient extremity (not shown) and the control and tensioning unit 1414 circumferentially pulls and releases the open-weave compression band to thereby apply the desired compression profile to the extremity.

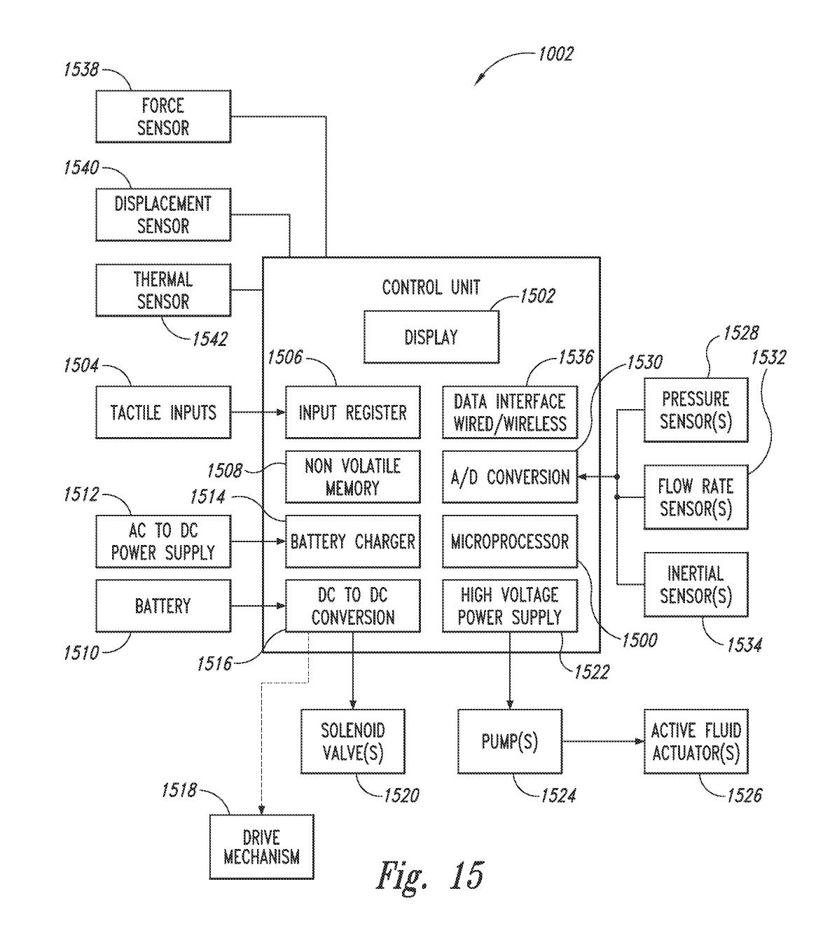

FIG. 15 is a functional block diagram of one embodiment of the control and tensioning unit 1002 contained in the compression device 1000 of FIG. 10, as well as any of the control units 108 (FIG. 1), control unit 212 (FIG. 2), control unit 814 (FIG. 8), and control unit 902 (FIG. 9) in the other previously described embodiments of compression devices. In the embodiment of FIG. 15, the control and tensioning unit 1002 includes some type of suitable microcontroller or microprocessor 1500 and controls the overall operation of the unit. The control and tensioning unit 1002 further includes an operator interface including a display 1502 and tactile input 1504, such as buttons, that allow a patient to provide input to the control and tensioning unit. An input register 1506 receives signals from the tactile inputs and stores these signals for use by the microprocessor 1500, such as adjusting a given compression profile based upon values of the tactile input 1504 and displaying information on the display 1502 responsive to the values for the tactile inputs contained in the input register 1506.

The control tensioning unit 1002 further includes a nonvolatile memory 1508 for use by the microprocessor 1500 to store data and also to store firmware for execution by the microprocessor and controlling the overall operation of the control and tensioning unit. Other types of memory, such as volatile memory like DRAM, could also be contained in the control and tensioning unit 1002. The control and tensioning unit 1002 further includes power components for supplying electrical power to the other components in the control and tensioning unit. In the embodiment of FIG. 15, the control and tensioning unit 1002 includes both a battery 1510 and a power supply 1512. In other embodiments, only the battery 1510 is utilized for power. By utilizing both, the battery 1510 may be a rechargeable battery, as is the case in the embodiment of FIG. 15 where the rechargeable battery is charged by a battery charger 1514 that receives power from the power supply 1512.

The control and tensioning unit 1002 further includes a DC-to-DC conversion circuit 1516 that receives power from either the battery 1510 or power supply 1512 and converts the received power to required voltage and current levels to drive other components contained in the control and tensioning unit 1002. In the embodiment of FIG. 15, these other components include a drive mechanism 1518, such as the drive mechanism 1400 of FIG. 14. In embodiments where were fluid is being transferred, such as the control units 108 and 212, solenoid valves 1520 may also be included and driven by the DC-to-DC conversion circuit. A power supply 1522 drives a pump 1524 in embodiments of the unit 1002 where fluid is being transferred, once again such as in the control units 108 and 212 previously described. The pump 1524 drives active fluid actuators 1526 through the fluid transfer generated by the pump, where the active fluid actuators could be the membranes 206 of FIG. 2, chambers 604 of FIG. 6, or bellows 704 of FIG. 7.

The control and tensioning unit 1002 further includes a number of different types of sensors, including pressure sensors 1528 for sensing various pressures that may be of interest during operation of the compression device containing the control and tensioning unit. For example, the pressure sensors 1528 could sense the pressure applied by the compression device to the patient extremity and the microprocessor 1500 could, for example, control the device so that a constant pressure or circumference is maintained, or a targeted pressure versus time profile is followed. Another pressure sensor 1528 may be used to measure localized pressure in certain zones of the fluid-filled outer sleeve 1006. This measurement could be used to for more sensitive readings, such as to detect heart rate, and could serve as a redundant measurement for the applied radial pressure for added safety. An analog-to-digital converter 1530 digitizes the signals from the pressure sensors 1528 for use by the microprocessor 1500. The control and tensioning unit 1002 may also include a force sensor 1538 or load cell to measure the force applied to slip compression band 1004, and the signals from the sensors are once again digitized by the analog-to-digital converter 1530 for use by to the microprocessor 1500 in controlling the operation of the compression device. The force measurement on the slip compression band 1004 correlates to the average radial pressure applied to the limb, therefore microprocessor 1500 can perform this real-time calculation for use in the system elsewhere. The control and tensioning unit 1002 may also include a displacement sensor 1540 or encoder to measure the circumference and/or change in circumference of slip compression band 1004, and the signals from the sensors are once again digitized by the analog-to-digital converter 1530 for use by to the microprocessor 1500 in controlling the operation of the compression device. As a safety measure, the measurement of circumference and/or change in circumference will allow the device to terminate application of treatment in cases where displacement thresholds are reached, as potentially defined by a medical professional. The control and tensioning unit 1002 may also include flow rate sensors 1532 and the signals from the sensors are once again digitized by the analog-to-digital converter 1530 for use by to the microprocessor 1500 in controlling the operation of the compression device. The control and tensioning unit 1002 may also include inertial sensors 1534, such as accelerometers and/or gyroscopes that sense movement of the patient and these signals are once again digitized by the analog-to-digital converter 1530 for use by the microprocessor 1500. Ambulatory state of the patient may be sensed through the inertial sensors 1534, as previously mentioned above, and utilized by the microprocessor 1500 to take appropriate action, such as controlling the compression device to apply a suitable compression profile when the inertial sensors 1534 indicate that the patient is sleeping. Finally, the control and tensioning unit 1002 may also include thermal sensors 1542 that measure limb temperatures or other system temperatures. These signals are once again digitized by the analog-to-digital converter 1530 for use by the microprocessor 1500. The control and tensioning unit 1002 further includes data interface and wireless communications circuitry 1536 for communicating with other control units, remote controls units, and/or computer systems (e.g. computer system 116 of FIG. 1), which could be a personal computer system, personal digital assistants or smart phones. Data interface functionality provided by the circuitry 1536 could include USB, Ethernet communications, Wi-Fi or BlueTooth, as a partial list of possibilities.

The control and tensioning unit 1002, in conjunction with the various sensors and the various embodiments of compression devices described, allows a wide array of programmable operational modes and physical characteristics of the system. Given the ability to perform closed-loop control of force and displacement, the system can be programmed to respond with a wide range of effective stiffnesses. For example, the device can behave in an inelastic (highly stiff) mode, whereby applied pressures and force do not cause any displacement. In another case, it may be desirable for the system to behave in an elastic manner with a target spring constant. In this case, the closed loop control system allows displacement in proportion to the applied load according to the target spring constant. In yet another case, a constant pressure may be required. In this case the control system adjusts the displacement in real-time to maintain the target applied pressure, no matter what perturbations are put into the system. Finally, it may be desirable to execute controlled pressure cycling according to defined pressure versus time profile. In this case the system drives displacement using inputs of applied pressure and time to follow the target profile.

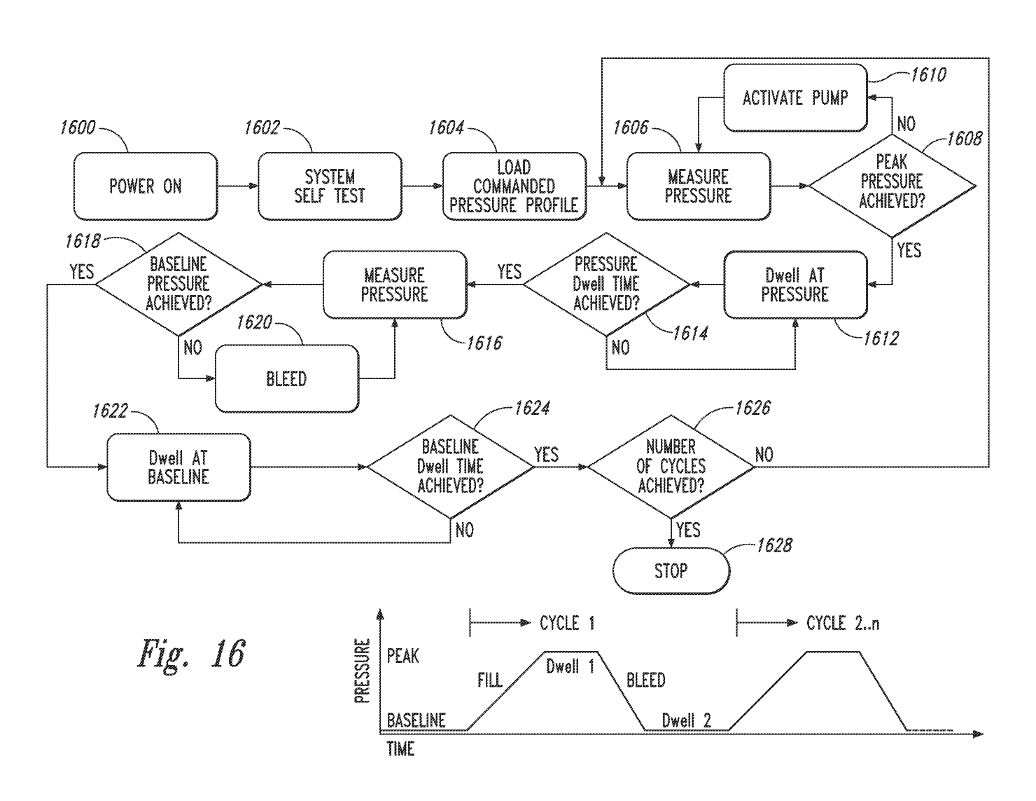

FIG. 16 is a flowchart showing the operation of the control unit 1002 of FIG. 15 during a typical compression cycle of the associated compression device. This compression cycle applies to embodiments such as the compression devices 102 (FIG. 1), 804-810 (FIGS. 8), and 900 (FIG. 9). The cycle process starts in step 1600 in which the compression device is powered ON and proceeds immediately to step 1602 in which a self-test is performed to ensure the associated compression device is operating properly. If this self-test in step 1602 is negative then operation terminates (not shown in FIG. 16) and some sort of indication is given to the user that there is a problem with the compression device, such as through a visual or audible indication.

Once the self-test of step 1602 has successfully completed, indicating the compression device is fully functional, the cycle process goes to step 1604 and the desired compression profile to be applied by the compression device is loaded. From step 1604, the cycle process proceeds to step 1606 in which the control and tensioning unit 1002 measures the pressure being applied to the patient extremity by the compression device. The cycle process then goes to step 1608 and determines whether a desired peak pressure has been achieved. When the determination in step 1608 is negative, the cycle process goes to step 1610 and the pump is activated to increase the applied pressure. Note that although the process of FIG. 16 indicates that a pump is activated in step 1610, in some embodiments there may not be a pump but instead the control unit activates whatever means it utilizes to increase the applied pressure of the corresponding compression device. For example, in the control and tensioning unit 1002 of FIG. 14 the drive mechanism 1400 would be activated to increase the applied pressure.

From step 1610, the cycle process goes back to step 1606 and measures the applied pressure, and then goes to step 1608 and determines whether the measured pressure has reached desired peak pressure. The cycle process continues executing steps 1608, 1610 and 1606 until the determination in step 1608 is positive, indicating the desired peak pressure has been achieved. When the determination in step 1608 is positive, the cycle process proceeds to step 1612 and “dwells” at the desired peak pressure for a desired dwell time. During this dwell time the desired peak pressure is maintained and thus the control and tension unit 1002 is said to “dwell” at this desired peak pressure.

From step 1612 the process goes to step 1614 and determines whether a set dwell time has expired. When this determination is negative, the process returns to step 1612 and continues to maintain or dwell at the desired peak pressure. The process then goes back to step 1614 and once again determines whether the dwell time has expired. The cycle process continues executing steps 1612 and 1614 until the determination in step 1614 is positive, meaning that dwell time has been reached. When the determination in step 1614 is positive, the process goes to step 1616 and once again measures the pressure applied by the compression device. From step 1616 the process goes to step 1618 and determines whether a baseline pressure has been achieved. When the determination in step 1618 is negative, cycle process goes to step 1620 and the pressure applied by the compression device is “bled” such that the applied pressure is lowered. The cycle process then goes back to step 1616 and the applied pressure is once again measured. The cycle process then returns to step 1618 and determines whether the desired baseline pressure has been achieved. The cycle process continues executing steps 1616 and 1618 until the desired baseline pressure, which is lower than the peak pressure, is achieved.

When the determination in step 1618 is positive, meaning that the desired baseline pressure has been achieved, the cycle process goes to step 1622 and maintains or dwells that the baseline pressure. From step 1620 the cycle process goes to step 1624 and determines whether a set dwell time has been achieved. As long as the determination in step 1624 is negative, the cycle process repeats steps 1622 in step 1624 to thereby dwell at the desired baseline pressure. Once the determination in step 1624 is positive, indicating that the pressure applied by the compression device has been maintained at the desired baseline pressure for the desired dwell time, the cycle process goes to step 1626 and determines whether the desired number of cycles have been executed.

When the determination in step 1626 is negative, the process goes back to step 1606 and once again executes steps 1606 1608 and 1610 to increase the pressure applied by the compression device to the desired the pressure. The process then once again execute step 1612 and 1614 to maintain the applied pressure at the desired peak pressure for the desired dwell time and then once again goes to step 1616, 1618 1620 to reduce the pressure to the desired baseline pressure. The process then once again goes to step 1622 in 1624 and maintains or dwells at the desired baseline pressure for the desired dwell time. At this point the process once again determines the steps 1626 and determines whether to the desired number of cycles has been executed. Cycle process continues executing in this manner until the desired number of cycles has been executed, at which point the determination in step 1626 is positive in the cycle process proceeds to step 1628 and terminates.

A graph at the bottom of FIG. 16 graphically depicts the pressure applied by the compression device as a function of time during execution of the cycle process just described. As seen in the graph, cycle process transitions from the baseline pressure to the peak pressure during a linear portion of the graph labeled “fill.” This corresponds to the execution of steps 1606, 1608 and 1610 in the flowchart. The cycle process then dwells at the peak pressure for the dwell time indicated as “Dwell 1” in the graph and this corresponds to the execution of steps 1612 and 1614. Similarly, the cycle process transitions from the peak pressure to the baseline pressure during a linear portion (negative slope) of the graph labeled “bleed.” This corresponds to the execution of steps 1616, 1618 and 1620 in the flowchart. The cycle process then dwells at the baseline pressure for the dwell time indicated as “Dwell 2” in the graph, which corresponds to the execution of steps 1622 and 1624 in the flowchart.

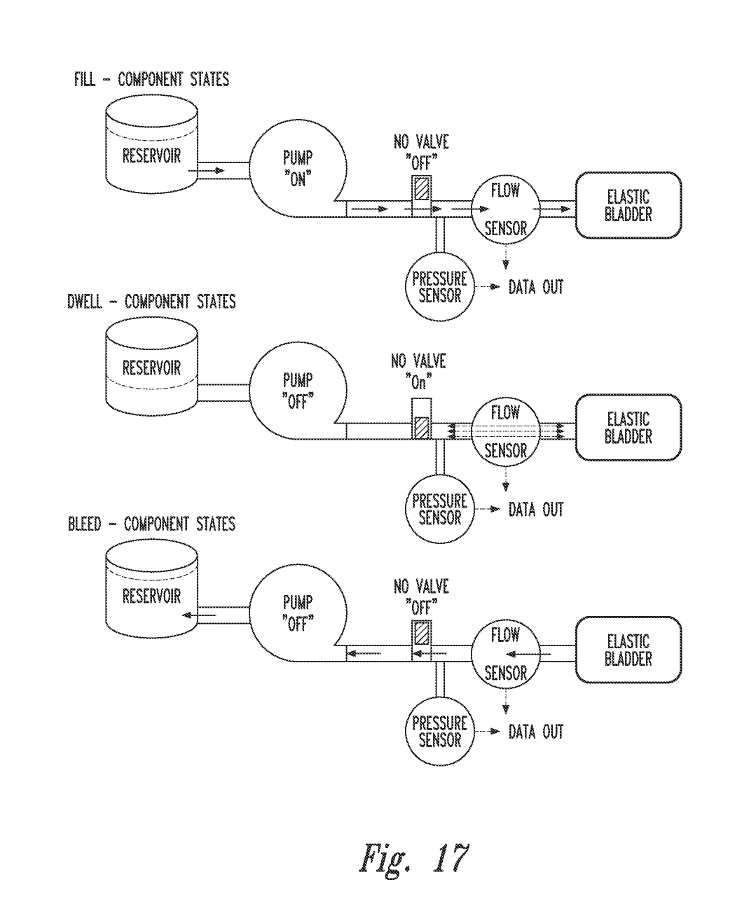

FIG. 17 is a functional diagram illustrating the three different compression states described in the flowchart of FIG. 16. More specifically, the top diagram in FIG. 17 illustrates the “fill state” such as executed in steps 1606, 1608 and 1610 in the flowchart of FIG. 16 and during which the applied pressure is increased from a lower pressure, typically the baseline pressure, to a desired peak pressure. As previously described, this is when the applied pressure is increased to a desired peak pressure. Accordingly, as illustrated in the top diagram of FIG. 17 during the fill state the pump is turned ON and a normally open (NO) valve is turned OFF, meaning the valve is open, such that the pump transfers fluid from the reservoir into an elastic bladder, such as the membranes 206 in FIG. 2.

The middle diagram in FIG. 17 illustrates the “dwell state” such as executed in steps 1612 and 1614 and steps 1622 and 1624 in the flowchart of FIG. 16. As previously described, this is when the applied pressure is maintained at the previously developed level, whether the peak pressure level or the baseline pressure level. During the dwell state the pump is turned OFF and the normally open (NO) valve is turned ON, meaning the valve is closed, such that the fluid transferred from the reservoir into the elastic bladder remains in the bladder and thus the pressure applied by the membranes 206 is maintained at approximately the same pressure for the dwell time.

Finally, the lower diagram in FIG. 17 illustrates the “bleed state” such as executed in steps 1616, 1618 and 1620 in the flowchart of FIG. 16, during which the applied pressure is decreased from the peak pressure to the baseline pressure. The pressure applied by the membranes 206 is decreased to the baseline pressure. Accordingly, as illustrated in the bottom diagram of FIG. 17 during the bleed state the pump is turned ON and the normally open (NO) valve is turned OFF, meaning the valve is open, such that the pump transfers fluid from the elastic bladder into the reservoir and thereby reduces the pressure applied by the elastic bladder.

Compression devices according to embodiments of the present invention are worn over or wrapped or placed around the portion of the body of interest. In operation, these compression devices assert a massaging or squeezing effect on the body. The above embodiments have been described as being used on humans but may be used on other mammals as well, and may be used on the upper arms, forearms, wrists, hands, thighs, calves, ankles and feet, and combinations thereof. If used on other mammals, such as smaller or larger animals, the compression devices device may be easily scaled to operate both on large and small animals and can be used on extremities or on larger portions of the animal's body.

The compression devices may utilized in a wide variety of different application, such in treating, diagnosing and preventing circulatory disorders. The compression devices can be worn by surgical patients, during and after surgery, for example. Another application is for people who spend substantial parts of most days lying down, or by the bedridden. In another application the compression devices may be worn by persons who spend substantial parts of the day immobile or substantially immobile, such as persons who sit for long periods of time in work, travel or leisure activities. The compression devices may function to shut OFF or enter a low power standby mode during extended periods of activity of the user, allowing more comfortable use by more active individuals. In some applications the compression devices may be worn by persons simply seeking the massage capabilities of the compression device.

As described with reference to the above described embodiments, the compression devices can include cuffs that are wrapped around a portion of the body requiring treatment and these cuffs typically include fastening mechanisms for tightening and securing the device around the body before use and quick release means for safety reasons. Examples of such mechanisms include without limitation hook and loop fasteners, snap fasteners, straps with tightening devices, spring locks and other adjustable fastener assemblies. In other embodiments, the device may be conformed to envelope an extremity with a specific configuration, such as the hand or ankle. In yet other embodiments, the size or shape of the device can be customized to an individual's body such that no manual adjustments are necessary once the device is placed around the body. In still further embodiments, latching or tensioning devices are employed so that the device can be simply adjusted with a minimum of steps. In some embodiments, the compression device can take the form of a single-piece cuff or sleeve that is slipped onto an extremity. The cuff can include contour aids for aligning the cuff on the extremity of interest, and include aids to align the cuff to focus constriction on the centerline of the calf or on other locations on the body. The cuff may also be configured to focus localized compressive pressure on such areas of interest.

In many embodiments, the compression device can be used in connection with a fabric sleeve or wrap, such as the protective outer sleeve 216 of FIG. 2. Such a sleeve can have an inner layer and an outer layer and be formed with a closable opening through which the device can be inserted. In such instances, the sleeve portions in contact with the patient's skin can be made from garment-quality fabrics for patient comfort. The wrap can be formed from fabrics that dry quickly or are designed to wick moisture away from the skin. To further improve patient comfort, in some instances the sleeve or wrap can be formed with an additional elastic fabric that also makes it easier to put the compression device on the patient. The sleeve materials can be impregnated with compounds to improve moisture resistance or to make the sleeves moisture-proof or substantially moisture-proof. In further embodiments the sleeve includes openings for fittings or connections to the device, and such openings may be designed to be self-sealing against moisture. In many cases, the sleeve or wrap can be separated from the device and washed. Alternatively, the sleeve or wrap can be disposable. The sleeve or wrap may be sterilized for use in hospital settings. In some embodiments the sleeve or wrap will include adjustment and fastening mechanisms such as hook and loop fasteners, snap fasteners, straps with tightening devices, rings, spring locks and other adjustable fastener assemblies. The sleeve or wrap can also be configured to be self-adjusting.

In some embodiments, the compression device includes a cuff having a bladder system, such as the bladder system 204a in the embodiment of FIG. 2. The bladder system contains compressible or incompressible fluid and may be an open or closed system with respect to the fluid. The incompressible fluid may be non-conductive, non-toxic, non-corrosive, or hydrophobic in nature. Incompressible fluids that may be used in embodiments of compression devices include hydrocarbon-based oils such as mineral oil and compositions including ethylene or propylene glycol or compositions comprising vegetable-based fluids such as beet juice. The fluids utilized would typically be non-toxic. The bladder systems can be formed from materials that are breathable, hypoallergenic, suitably elastic, non-reactive to fluids or puncture resistant. Such materials include heat sealable nylon, such as heat sealable 30 denier ripstop nylon, flexible polyvinyl chloride sheeting, and flexible vinyl sheeting. The bladder system can include a flexible band (see hoop stress band 202 in embodiment of FIG. 3) that is partially or wholly disposed around an extremity. The band has an inner side facing the body and an outer side facing away from the body and is formed material that is sufficiently stiff such that the band is capable of carrying any hoop stresses generated by the compression device. The band may be fitted with adjustment and fastening mechanisms previously described to allow a patient to adjust the band and on his or her own body and may also be self-adjusting.

In embodiments of the present invention that include a pump, such as the pump 208 of FIGS. 2 and 3, the pump may be integral or external to the compression device (shown as integral in the embodiments of FIGS. 2 and 3). Furthermore, the compression devices may include integral flow rate metering valves and/or pressure transducers. In embodiments where compression device utilizes an incompressible fluid an integral hydraulic pump may be used. The pump may be positioned to move fluid between a reservoir and the membranes in a closed bladder system such that membranes expanded by incompressible fluid pumped from the reservoir impart a controlled pressure on the patient's extremity. In some embodiments, the cuff further includes porting assemblies including manifolds (see porting assembly 210 and manifold 302 of FIG. 3) that assist the pump in uniformly transferring fluid between the reservoir and the membranes in a closed bladder system.

The pump 208 or pumps in any of the described embodiments may be mechanical, electrical or electromechanical in nature, and may be powered by batteries to improve portability of the device. The pump is used to achieve appropriate pressures in the device to result in application of compressive stress to the areas of interest. The pump is typically capable of rapid cycling and rapid filling rates. In addition, the pump may be removable and replaceable in the event the pump fails or in the event other compression device components fail. In some embodiments, the pump includes an electroactive polymer that functions as the pump actuator. The term “electroactive polymers” generally describes piezoelectric materials that mechanically deform with a high strain output under low voltage electrical input or stimuli. The mechanical deformation is precise such that highly controlled incremental changes in deformation can be achieved. In addition, the electroactive materials are lightweight, resilient and silent in operation. Therefore, pumps comprising electroactive polymers are quiet in operation and can be configured to work substantially without noise. The use of electroactive polymers also reduces the size of the pump due the materials higher power density and their use reduces or eliminates the need for gear reduction designs or separate force pressure transducers. The use of electroactive polymers allows the pump to be cost efficient.

The compression devices can include failsafe mechanisms such as integral vacuum relief valves and two-way flow control valves to improve the safety of the devices. In some embodiments the cuff, such as cuff 200 of FIGS. 2 and 3, includes a valve system including one or more integral fluid control valves disposed between the reservoir (e.g., reservoir 214) and the membrane (e.g., membranes 206) of a closed bladder system (bladder system 204 of FIG. 2). The valve system can also include fluid control valves integral to the pump which, when open, permit the flow of fluid through the valve and act as check valves when closed to prevent damage to the pump. The valves can be two-way valves that permit bleeding down when closed. Of course, a combination of one-way and two-way valves may be used in the valve system. The valves can also be failsafe and remain in the open position when the device is off. In other embodiments, pressure control or fluid flow is achieved through modulation of the pump rather than through the exclusive use of valves.

In some embodiments the cuff, such as cuff 200 of FIGS. 2 and 3), include without limitation one or more pressure sensors, flow rate sensors, temperature sensors, and inertial or motion sensors. These sensors can be arrayed on any part of the compression device and can be integral to components of the cuff, such as bladder system and the pump. Micro Electro-Mechanical Systems (MEMS) methods may be employed for the design and manufacture of many of these sensor types, including but not limited to pressure, flow rate, acceleration and angular rate sensors. MEMS sensors typically utilize an active transducer designed to detect small changes in capacitive values indicating a value of the desired measured characteristic. In addition to MEMS other pressure and flow rate sensors include those sensors that utilize electroactive polymers to sense changes in pressure or flow rates. Yet other sensors include shape memory alloys and magnets or magnetic materials. Examples of temperature sensors include solid state temperature sensors such as those in the “AD590” family of temperature transducers. Examples of inertial sensors include accelerometers and gyroscope-based sensors. Inertial sensors are capable of measuring small changes in acceleration or rotation rate which can then be integrated as a function of time to estimate relative velocity, relative position or relative rotation angle. Such sensors can be configured to detect movement through acceleration and/or rotation rate in up to three axes and therefore allow sensing of when the user of the device is awake, asleep and/or ambulatory. Such inertial sensors may also serve as switching elements and may be self-indexing and self-calibrating. In response to inertial sensor information the compression device may be switched off when the sensors detect that the patient is sleeping, or placed into a sleep or idle mode when the patient is moving, standing or walking. Thus the portability and extended use of the device is improved by conserving the operational life of the battery.

In some embodiments of compression devices according to the present invention, the control unit, such as control unit 212 of FIG. 2, is removably attached to the corresponding cuff. In such situations circuitry and connections are provided in the cuff for the attachment and removal of the control unit. The control unit will typically be battery operated. The battery may be removable and rechargeable. The control unit should ideally operate at low power levels to conserve electrical power and extend battery life. In other embodiments, the device is configured for standard power supplies available within the home or in medical care settings and can be used continuously. For example, a device that is plugged into an AC wall power supply may be operated at 115V continuously for over twenty-four hours at a time.

The control unit may have a user interface that allows a user or caregiver to control the device by entering appropriate input through tactile interfaces. In many cases, the user interface comprises a user display that reports the status or operation mode of the device upon request. The user interface may also in some cases display information regarding the battery usage of the device, the usage of the device in comparison to target usage, and any error or fault codes for the device. Faults include without limitation power faults, sensor faults, and memory faults. In such cases the user interface and display should be configured to be readable to the user when the device is worn.

The control unit typically includes a microprocessor that controls the actuation of pumps or other drive mechanisms and controls the compression device power circuitry. The microprocessor may includes a digital signal processor, and may control power circuitry, electrical charging circuitry, and safe-operation circuitry such as ground fault interruption and arc fault protection circuitry. Such circuitry together with the pump, power supply as applicable and power conversion circuitry can be separately enclosed in a scaled enclosure. The microprocessor includes logic circuitry that processes and uses sensory data from the sensors and any user input to control operation of the device. The microprocessor also controls actuation of the pumps in accordance with a programmed compression profile such as a therapy sequence or profile, or in accordance with calibration or deep vein thrombosis detection sequences, for example. The microprocessor can also be utilized to calibrate, analyze and store the baseline measured characteristics and vital signs for individual users and patients. The control unit may also comprise a device for storage of data, such as, without limitation, a patient's measured physiological characteristics, calibration information, and use metrics. Non-volatile FLASH memory devices may be used for such storage. The control unit may also include a wireless interface, wireless data transmitter and/or receiver that can be used to exchange data with other control modules or other remote interfaces. Examples of such interfaces include user remote controls, computers, personal digital assistants or wireless telephones or smart phones. Of course the control unit may also include ports, such as universal serial bus (USB) ports, for wired external connections to such interfaces for data exchange or download.

The control unit may also include inductive power coupling devices and may also provide real-time measurements of pressure, fluid flow rates, temperature and motion that can be recorded and displayed either on a user interface on the control unit or on a remote computer through wired or wireless means. The control unit may be responsive to real-time input from the user or caregiver including turning the device on and off or placing the device into sleep or idle modes, changing pulsing or compression cycle frequency or changing pulsing or compression cycles from synchronous to asynchronous between different cuffs or devices as described further below. Thus the microprocessor of the control unit can be programmed to respond to sensor feedback in either closed loop or open loop feedback processing. In some cases, the control unit regulates and controls pressure within the bladder system through active control of the pump and active monitoring and measuring of the pressure within the bladder system using sensor feedback and measurements while in other cases the control unit is configured to estimate fluid flow volume using hydraulic pump input voltage, pressure, incompressible fluid temperature, and time-related measurements.

One application of the above-described embodiments is use in treating patients with venous thrombosis by attaching an apparatus of the disclosure to an extremity of the patient. The pump of a compression device placed around the extremity is the actuated to supply the necessary pressure or vacuum to cause the expansion of membranes or chambers or to cause the contraction of bellows elements, as applicable. Pump actuation coordinated with valve operations continue until a target pressure is achieved, as measured by pressure sensors located in the bladder system or by pressure sensors located on the bladder system adjacent to the extremity. The valves between the reservoir and the membranes may be open during this period until the membranes arc filled with fluid to a target pressure which is measured and recorded. The target pressure can be maintained by valve closure, pump modulation, or a combination of these approaches. Pump modulation operates in a closed-loop control manner through continuous monitoring the pressure level with the bladder system, and adjusting the pump output to maintain the target level. Techniques for pump modulation and regulation such as pulse width modulation or continuous voltage input adjustments and other techniques are known to those skilled in the art.

After the target pressure is maintained for a determined amount of time the fluid or vacuum is released and returned to the reservoir as applicable, as described with reference to the embodiment of FIG. 16. The cycle is repeated according to programmed requirements and may be sequential or intermittent. In cases involving more than one compression device the compression cycling can be coordinated to occur randomly, concurrently or sequentially among the compression devices. Any combination of synchronous or asynchronous cycling or cycle frequency can be achieved to meet patient needs. Such compression cycling coordination can take place through wireless communication through the use of wireless data transmitters and receivers as described with reference to the embodiment to the compression system 100 of FIG. 1. This process may, of course, be used on extremities without venous thrombosis as a means of increasing fluid circulation and flow through the extremity. Increasing fluid circulation and flow has been indicated as a way of preventing the development of deep vein thrombosis.

Other embodiments include methods of characterizing stiffness characteristics of a portion of the body around which a compression device is placed. The compression device can utilize a single bladder system which is actuated concurrently with the sensors such that a separate reference bladder system is not required. The pump of the compression device is actuated to supply the necessary pressure or vacuum to cause the expansion of membranes, or to cause the contraction of bellows elements as applicable. The pump is operated until a first, higher target pressure is achieved, as measured by pressure sensors located in the bladder system or by pressure sensors located on the bladder system adjacent to the extremity. The time required to reach the first, higher target pressure is measured and recorded. During this time period, the pressure exerted by the bladder system, as well as the pump voltage, incremental volumetric displacement and fluid temperature, are repeatedly measured, along with a precise time record of each measurement, until the target pressure is reached. After the target pressure is reached, pump actuation ceases and the bladder system is allowed to return to a second, lower target or baseline pressure through powered or passive “backfeed” through the pump and fluid control valves, if used. The time required to reach the lower target pressure is measured and recorded. During this second time period the pressure exerted by the bladder system, as well as the pump voltage, incremental volumetric displacement and fluid temperature, are repeatedly measured until the second, lower target pressure is reached, after which the valves may be moved into closed positions or pump modulation is enabled. The pressures, volumetric displacements and times are recorded in data storage components of the device or exported to an external memory. The data is used to quantify a stiffness characteristic that can be described as the relationship between the data and applied pressure, which is analogous to an applied force as a function of volumetric displacement analogous to radial displacement of the device by the body. With sufficient measurements a baseline physiological stiffness characteristic may be determined. In a similar manner other stiffness characteristics can be determined by quantifying the relationship between applied pressure and applied pump voltage, device output pressure, fluid temperature, or time, for example. Compression cycles may be repeated to accumulate sufficient data to quantify the standard deviation of the stiffness characteristics to establish baseline stiffness characteristics, or to accumulate sufficient data to distinguish between normal “variation” in the stiffness characteristics from statistically significant physiological changes in the subject. The data collected can also be used to chart or visualize flow rates and pressures, or other measurements, over the cycles or over time periods.

Further embodiments are directed to methods of detecting fluid flow changes in the body that may indicate the presence of deep vein thrombosis. One embodiment includes determining baseline stiffness characteristics as described herein and repeating the compression cycling and measurement of stiffness characteristics to compare the characteristics against the baseline data. The measurements can be taken at both higher and lower fluid flow rates to establish fill rate dependency in the baseline extremity stiffness characteristics at each rate. Changes in the stiffness characteristics beyond the baseline stiffness characteristics or the normal distribution of repeated baseline stiffness characteristic measurements signal the potential development of deep vein thrombosis and indicate a need for further investigation, diagnoses or treatment.

Other embodiments are directed to methods of detecting fluid flow changes in the body that may indicate the presence of deep vein thrombosis through the use of two or more bladder systems. In such cases one of the bladders systems and pumps is placed proximate to the heart of the patient and the other is placed distal to the heart around an extremity. The distal pump is actuated to supply the necessary displacement pressure or vacuum to cause the expansion of membranes or chambers or to cause the contraction of bellows elements, as applicable. Pump actuation continues until a first higher target pressure is achieved as measured by pressure sensors located in the bladder system, or by pressure sensors located on the bladder system adjacent to the extremity. The higher pressure in the distal pump is accomplished through coordinated valve actuation or pump modulation as previously described herein. The pressure in the bladders system is increased to cause constriction in the patient's extremity and hypertension in the patient's deep veins. The proximate pump is also actuated to supply the necessary displacement force or vacuum pressure to cause the expansion of membranes or chambers or to cause the contraction of bellows elements, as applicable. Proximate pump actuation continues until a second lower target pressure is achieved as measured by pressure sensors located in the bladder system or by pressure sensors located on the bladder system adjacent to the extremity. The target pressure in the proximate bladder is a lower reference pressure that supports venous flow feedback measurements. Maintenance of the lower target pressure in the proximate pump is accomplished through coordinated valve actuation or pump modulation as previously described herein. When the target pressures are reached the distal pump ceases actuation and the distal bladder system is commanded to release fluid or vacuum pressure. The extremity will swell as the distally accumulated fluid flows towards the proximate bladder system. The proximate bladder system will experience a transient increase in pressure from the extremity after which the proximate bladder system is then released and the reduction of vacuum pressure until the second lower pressure is achieved through powered or passive back feed. The time required to reach the lower target pressure in the proximate cuff again is measured and recorded. Throughout the entire process the pressure exerted by the distal bladder system as well as the pump voltage and fluid temperature are repeatedly measured until the second lower target pressure is reached. Associated time records and pump modulation parameters can also be recorded, as applicable. The data are recorded in storage components of the device or exported to an external memory. The data can be used to chart flow rates and pressure over cycle time periods. Repeated compression cycling and measurement of stiffness characteristics collects data to be used creating a baseline profile and data collected in subsequent cycles is compared to the baseline stiffness characteristics. Changes in the stiffness characteristics signal the potential development of deep vein thrombosis and indicate a need for further investigation, diagnoses or treatment.

Further embodiments are directed to methods to collect stiffness characteristics from different extremities such as both calves of a patient. Changes in these characteristics between the extremities may indicate the development of deep vein thrombosis in one of the legs and indicate a need for further investigation, diagnoses or treatment. These embodiments may be practiced with compression devices that employ interconnected chambers or contractible bellows in lieu of bladder systems. The methods may also be practiced with a combination of interconnected chambers and contractible bellows and bladder systems in the cuffs of the compression device. Such methods may also be modified to alert the patient or caregiver to the potential presence of deep vein thrombosis when measured characteristics, such as time periods for reaching certain pressure levels or flow rates during pressure reduction phases, differ from baseline measured characteristics. Increases in the time required to reach a second lower pressure or a reduction in the backfeed flow rate for example, may be characteristic of a reduction in the resistance of the targeted extremity against a known pressure or a reduction of the “spring constant” of an extremity. Such reductions may indicate the existence of blood clot. These methods may be repeatedly performed to assess the patient's baseline physiological characteristics as well as repeatedly performed to diagnose the existence of deep vein thrombosis. The methods may be further modified to alert the patient or caregiver when programmed thresholds are exceeded when faults have occurred when battery life is low, or when the actuators on different cuffs are cycling outside of programmed parameters. The operation of the compression devices may be suspended if failsafe conditions are exceeded.

In another embodiment software algorithms for device usage are modified according to an individual's body geometry such as leg or calf diameters, vital signs, baseline characteristics, range of motion, percentage muscle or fat on the patient's body, and other patient parameters that influence the device's ability to generate a predictable increase in venous flow. In addition, software algorithms may be modified based on statistical sampling or real-time sensor feedback.

Embodiments of the present invention utilize improved sensitivity in measurements via the described bladder systems that have highly sensitive pressure or flow rate sensors that measure minute changes in bladder volume and pressure which in turn reflect changes in limb or extremity volume displacement. Additionally, the compression devices can measure changes in resistive pressure in the extremity, with an increase in resistance indicating an increase in stiffness or pressure in the extremity and a potential diagnosis of thrombosis. Also, an increase in temperature of the extremity in the venous refill phase can also indicate the presence of thrombosis, as venous blood is trapped or obstructed. It will be clear to those in the art that the means for diagnosing deep vein thrombosis using the compression devices are not limited to the provided embodiments. It will also be clear that these embodiments may be combined to provide a highly sensitive measurement system with a compression device that can be used for the treatment of deep vein thrombosis or other circulatory condition or disorder.

In one embodiment the compression device applies intermittent or scheduled compressive pressure to an extremity. The device can be worn over any part of the body, including without limitation extremities such as the foot, ankle, calf, and thigh. A cuff substantially surrounds or envelopes the portion of the body to be treated. The cuff is then snugly secured in place around the patient's extremity. The compression device may include a bladder system that includes one or more elements that can be inflated, expanded and/or contracted. The compression device may be secured around the patient's extremity when the bladder system is unexpanded or minimally inflated. The inflatable or expandable elements, which are commonly placed adjacent to the body, expand under the influx of a compressible or an incompressible fluid and squeeze the extremity. The compression device also may be secured around the patient's extremity when the bladder system is not subject to vacuum pressure. The bladder system elements in these cases will contract under vacuum pressure to provide compressive pressure on the extremity.

The bladder system can include one or more membranes that are adjacent or near the patient's skin. The membranes may be attached or connected to a band that is secured around the patient's extremity. In other embodiments, the bladder system will include one or more cell-like chambers. The chambers may be separated by flexible dividers that allow the assembly of chambers to flex and form around the patient's extremity. When included in the device, the chambers may be expanded to provide compressive pressure on the extremity. In yet other embodiments, the bladder system may include one or more bellows that contract or expand in response to changing vacuum pressure levels. In these instances, contraction of the bellows increases the pressure of the device on the extremity. Of course, any combination of the above elements may be used in other embodiments.

The bladder systems of work in connection with a pump that may be pneumatic or hydraulic. Compressible or incompressible fluid may originate in a separate reservoir or container that is part of the device or separated from the device by appropriate tubing, channels or other delivery means. The fluid or gas reservoir, when connected to a closed bladder system, results in substantially silent operation without the noise associated with the exhaust of gas or fluid to the ambient environment. The pump may deliver gas or fluid to expandable elements or it may subject contractible elements to vacuum pressure. In some embodiments the pump is actuated by an electroactive polymer.

The pump may be designed to operate silently or substantially without noise. The pump works in connection with valves and/or sensors. Valves may be disposed between the bladder system elements and the sources of gas or incompressible fluid. Examples of valves include without limitation solenoid valves, proportioning valves, pinch valves, one-way valves, and valves comprising shape memory alloys such as nitinol. Examples of sensors include pressure sensors, flow rate sensors, temperature sensors, inertial (angular rate and acceleration) sensors, infrared sensors, current sensors, voltage sensors, proximity sensors, Hall effect sensors, touch sensors, quantum tunneling composite sensors, time-domain sensors, and frequency-domain reflectometry sensors.

In some embodiments, the functions of an integral valve, and sensors, are integrated into the pump. The pump, sensors and valves can be monitored and controlled by a control unit that is a permanently or removably attached component. The control unit may include batteries. power converters, high voltage power sources, microprocessors, digital processors, data storage devices, sensors, sensor interfaces, wireless communication circuitry, wireless data transmitters and receivers, visual displays, wireless interfaces, user interfaces, pumps, valves, manifolds and mechanical or electrical connectors.

In one embodiment, a compression device includes more than one bladder system or more than one pump but only a single control unit that coordinates operation of the bladder systems and pumps, as well as all of the valves and sensors in the device. The control unit may coordinate the pump and bladder operation to suit therapeutic need or patient comfort, including controlling the ramp-up of applied pressure or temperature. To improve patient comfort and ease of use, the control unit may be battery operated to improve portability.

In another embodiment includes one compression device on the patient's extremity. The operation of the bladder systems and pumps can be coordinated with respect to cyclic compression to meet therapeutic or patient needs. Coordination can be facilitated by wireless data transmitters and receivers located in the control units of the devices. Examples of suitable wireless communications include BLUETOOTH® wireless transmitters and receivers and radio frequency identification tags (RFID) and associated readers. In some embodiments the coordination between devices is alterable in response to input provided by the patient or the physician from a remote user interface.

Other embodiments are directed to treating patients with venous thrombosis by attaching a compression device to an extremity of the patient. The cuff of a compression device is placed around the extremity and is used to compress targeted portions of the patient's extremity, such as the calf muscle. The compressive pressure is generated by the circumferential contraction of the compression device around the extremity or by the inflation of a bladder adjacent to the extremity that is restricted by a substantially inelastic band or strap.

Still further embodiments are directed to methods of characterizing stiffness characteristics of a portion of an extremity around which the compression device is secured. The methods may be conducted with a compression device having a single bladder system that may provide compressive pressure actuation and sensory feedback simultaneously, thereby eliminating the need for a separate bladder system reference to provide additional sensory input. The pump of a device placed around the extremity is actuated to apply the necessary pressure or vacuum to cause the expansion of membranes or chambers or to cause the contraction of bellows elements, as applicable, while sensor elements record data such as pressure and volumetric displacement. Such measurements are recorded over multiple time intervals within each of one or more contraction cycles to quantify a stiffness characteristic as the relationship between applied pressure or force as a function of volumetric displacement or radial displacement as baseline physiological characteristics. The methods disclosed herein that utilize incompressible fluids enable the accurate estimation of volumetric displacement as a function of other easily measured values including but not limited to applied voltage, output pressure, fluid temperature, and time. Extremity stiffness characteristics may also include such measurements and comparisons.

Other methods are directed to collecting stiffness characteristics from different extremities such as both calves of a patient. Changes in these characteristics between the extremities may indicate the development of deep vein thrombosis in one of the lower legs and indicate a need for further investigation diagnoses or treatment. Still other methods include methods of detecting fluid flow changes in the body that may indicate the presence of deep vein thrombosis. These methods include determining baseline stiffness characteristics as described herein, and repeating the compression cycling and measurement of stiffness characteristics to compare the subsequently measured characteristics against the baseline data. Changes in the stiffness characteristics signal the potential development of deep vein thrombosis and indicate a need for further investigation, diagnoses or treatment.

Other methods include detecting fluid flow changes in the body that may indicate the presence of deep vein thrombosis through the use of two or more bladder systems and pumps to assess the venous fill characteristics of the targeted extremity. Other methods detect temperature changes in the body or detecting heat exchange between the body and the bladder system that may indicate the presence of deep vein thrombosis through the use of temperature sensors disposed on compression devices. Further methods provide massage to users through repeated compression on the targeted extremity.

One skilled in the art will understand that even though various embodiments and advantages of the present invention have been set forth in the foregoing description, the above disclosure is illustrative only, and changes may be made in detail, and yet remain within the broad principles of the invention. Moreover, the functions performed by various components described above may be implemented through circuitry or components other than those disclosed for the various embodiments described above. Moreover, the described functions of the various components may be combined to be performed by fewer elements or performed by more elements, depending upon design considerations for the device or system being implemented, as will appreciated by those skilled in the art. Therefore, the present invention is to be limited only by the appended claims.

1. A compression device, comprising:
a compression band adapted to be placed around an extremity of a patient to apply compression to the extremity, the compression band being formed from an inelastic material and having a circumference when in place around the extremity; and
a control and tensioning unit coupled to the compression band and operable to control a circumferential displacement of the compression band to control the compression that the compression band applies to the extremity.

2. The compression device of claim 1, wherein the control and tensioning unit controls the compression band to apply inelastic compression to the extremity.

3. The compression device of claim 1,
wherein the control and tensioning device is further operable to monitor the pressure the compression band applies to the extremity; and
wherein the control and tensioning device is further operable to control the circumferential displacement of the compression band responsive to the monitored pressure.

4. The compression device of claim 3, wherein the control and tensioning unit is operable in response to the pressure applied by the compression band reaching a minimum pressure threshold to increase the circumferential displacement of the compression band and thereby decrease the circumference of the compression band.

5. The compression device of claim 3,
wherein the control and tensioning unit is operable in response to the pressure applied by the compression band reaching a maximum pressure threshold to decrease the circumferential displacement of the compression band and thereby increase the circumference of the compression band.

6. The compression device of claim 5, wherein monitoring the pressure includes sensing the instantaneous pressure applied over time.

7. The compression device of claim 5,
wherein monitoring the pressure includes sensing the instantaneous pressure applied over time; and
wherein the control and tensioning unit is operable in response to a moving average of the sensed instantaneous pressure reaching the minimum or maximum pressure threshold, the moving average being calculated using the values of the sensed instantaneous pressure.

8. The compression device of claim 1, wherein the control and tensioning unit is further operable in a non-ambulatory mode to set the circumference of the compression band at a first constant value for a first time interval and is operable to maintain the circumference of the compression band at a second constant value for a second time interval.

9. The compression device of claim 8,
wherein the first constant value is less the second constant value; and
wherein the control and tensioning unit is operable to alternately set the circumference of the compression band at the first and second values during a cycle time of operation.

10. The compression device of claim 9, wherein the control and tensioning unit is operable to adjust the ratio of the first time interval to the cycle time to apply a desired average pressure to the extremity.

11. The compression device of claim 1, where in the compression band comprises an open-weave material.

12. The compression device of claim 1, wherein the compression band comprises a corset-type compression band.

13. The compression device of claim 1, wherein the compression band comprises:
a slip compression band; and
a fluid-filled outer sleeve adapted to surround the slip compression band and interface directly with the extremity.

14. The compression device of claim 13 wherein the fluid-filled outer sleeve comprises a plurality of fluid-filled cells.

15. The compression device of claim 1,
wherein the control and tensioning unit further comprises inertial sensors operable to sense an ambulatory or non-ambulatory state of the patient; and
wherein the control and tensioning unit is further operable to adjust the pressure applied by the compression band responsive to the sensed ambulatory or non-ambulatory state.

16. The compression device of claim 1, wherein the control and tensioning unit is operable to control the circumferential displacement of the compression band to apply constant pressure to the extremity.

17. The compression device of claim 1, wherein the control and tensioning unit is further operable to limit further circumferential displacement responsive to a minimum circumference associated with extremity being reached.

18. The compression device of claim 1, wherein the control and tensioning unit controls the compression band to operate in an elastic manner, the compression band being controlled to have a target spring constant.

19. A compression system, comprising:
a compression device, including,
a compression band adapted to be placed around an extremity of a patient to apply inelastic compression to the extremity, the compression band having a circumference when in place around the extremity;
a control and tensioning unit coupled to the compression band and operable to control a circumferential displacement of the compression band to control the inelastic compression the compression band applies to the extremity; and
a computer system operable to communicate with the control and tensioning unit to control the operation of the compression device.

20. The compression system of claim 19, wherein the compression system further comprises a plurality of compression devices.

21. The compression system of claim 20 further comprising a remote control unit operable to communicate with the compression devices and the computer system and to control the operation of the communication devices.

22. The compression system of claim 20 wherein each of the compression devices is further operable to communicate with the other compression devices to synchronize the operation of the plurality of compression devices.

23. A method of treating circulatory conditions, comprising:
applying compression to an extremity of a patient through an inelastic compression band having a circumference; and
controlling the circumference of the inelastic compression band to apply a desired compression profile to the extremity.

24. The method of claim 23 wherein the operation of controlling comprises setting the circumference of the inelastic compression band to a fixed value.

25. The method of claim 23 wherein the operation of controlling comprises varying the circumference of the inelastic compression band to apply a fixed pressure to the extremity.

26. The method of claim 23 wherein the operation of controlling comprises:
sensing a characteristic of the patient; and
controlling the circumference of the inelastic compression band as a function of the sensed characteristic.

27. The method of claim 26 wherein the sensed characteristic comprises one or more of the patient's ambulatory or non-ambulatory state, temperature of the extremity, and force the compression band applies to the extremity.

28. The method of claim 23 wherein the operation of controlling comprises controlling the circumference of the inelastic compression band to apply a desired compression profile to the extremity to detect the existence of a circulatory condition.

29. A portable device for applying compression to an extremity of a mammal comprising:
a cuff comprising;
a closed bladder system;
incompressible fluid in said closed bladder system; and
a hydraulic pump.

30. The portable device of claim 29, wherein said cuff further comprises a sensor system.

31. The portable device of claim 30, wherein said cuff further comprises:
a band disposable around said extremity, said band comprising an inner side and outer side; and
wherein said closed bladder system comprises one or more membranes disposed on the inner side of said band and a reservoir disposed on the outer side of said band.

32. The portable device of claim 30, wherein said closed bladder system comprises a plurality of interconnected chambers.

33. The portable device of claim 29, wherein said hydraulic pump comprises an electro-active polymer.

34. The portable device of claim 29, wherein said hydraulic pump is configured to operate substantially without noise.

35. The portable device of claim 31, wherein said device further comprises a valve system with one or more fluid control valves disposed between said reservoir and said membranes, and wherein said sensor system comprises one or more sensors that detect pressure, flow rate, and/or temperature.

36. The portable device of claim 31, wherein said sensor system comprises one or more sensors that detect pressure, flow rate, temperature and/or inertial sensors.

37. The portable device of claim 31, wherein membranes expanded by incompressible fluid from the reservoir impart a controlled pressure on said extremity.

38. The portable device of claim 35, wherein said device further comprises a battery operated control unit removably attached to said cuff.

39. The portable device of claim 38, wherein said control unit comprises a wireless data transmitter and receiver.

40. The portable device of claim 36, wherein said device further comprises a battery operated control unit removably attached to said cuff, said control unit measuring hydraulic pump input voltage and recording time, and wherein said sensors are configured to measure pressure and incompressible fluid temperature, said control unit configured to estimate a fluid flow volume using said measurements.

41. The portable device of claim 36, wherein said device further comprises a battery operated control unit removably attached to said cuff, and wherein said sensors are configured to measure pressure with said bladder system, said control unit controlling pressure within said bladder system by actively measuring said pressure and actively controlling said pump.

42. The portable device of claim 36 further comprising a method of treating a patient having deep vein thrombosis, said method comprising:
(a) attaching a device according to claim 36 to an extremity of said patient;
(b) actuating the hydraulic pump;
(c) filling the bladder system with incompressible fluid from the reservoir;
(d) measuring the pressure exerted by the bladder against the extremity with a pressure sensor;
(e) modulating the hydraulic pump to maintain a target pressure; and
(f) ending pump actuation and allowing fluid from the bladder to return to the reservoir, and
wherein compression cycle steps (b) through (f) are repeated.

43. The method of claim 42, wherein said device further comprises a single battery operated control unit comprising a wireless data transmitter and a receiver.

44. The method of claim 43, wherein a second device is attached to another patient extremity, and wherein the compression cycling in said the devices is coordinated through said wireless data transmitters and receivers.

45. The method of claim 42, wherein said device further comprises a second cuff comprising a closed bladder system, an incompressible fluid in said closed bladder system and a hydraulic pump, and wherein said compression cycling in each cuff is controlled by a single battery operated control unit removably attached to one of said cuffs.

46. The method of claim 45, wherein the first cuff is proximate and the second cuff is distal to the heart of said patient, further comprising:
actuating the pump in the distal cuff until the bladder system exerts a known first pressure against the extremity;
actuating the pump in the proximate cuff until the bladder system exerts a known, lower second pressure against the extremity;
releasing fluid from the bladder system of the distal cuff;
repeatedly measuring the pressure exerted by the bladder system of the proximate cuff against the extremity until the lower second pressure is reached;
measuring the time required to reach the lower second pressure;
storing said measurements in said control unit as extremity stiffness characteristics; and
comparing said extremity stiffness characteristics against known baseline extremity stiffness characteristics,
wherein a change in the extremity stiffness characteristics is an indicator of the presence of deep vein thrombosis in the extremity.

47. The portable device of claim 40 further comprising a method for characterizing the stiffness of an extremity comprising:
(a) attaching a device according to claim 40 to an extremity of said patient;
(b) actuating the hydraulic pump;
(c) filling the bladder system with incompressible fluid from the reservoir;
(d) measuring the time required to reach a first, higher target pressure;
(e) repeatedly measuring the pressure exerted by the bladder system against the extremity and the incremental volumetric displacement of the incompressible fluid until said first target pressure is reached;
(f) modulating the hydraulic pump to maintain said first target pressure;
(g) ending pump actuation and allowing fluid from the bladder to return to the reservoir;
(h) measuring the time required to reach a second, lower target pressure;
(i) repeatedly measuring the pressure exerted by the bladder system against the extremity and the incremental volumetric displacement of the incompressible fluid until said second target pressure is reached;
(j) storing said pressure in comparison to said and incremental volumetric displacement measurements in said control unit as extremity stiffness characteristics; and
(k) repeating (b) through (j) to establish a sufficient number of times to quantify statistical mean and short term variations in baseline extremity stiffness characteristic measurements.

48. The portable device of claim 47 further comprising a method for detecting changes in fluid flow within an extremity of a mammal, comprising:
(a) attaching a device according to claim 47 to an extremity of said patient;
(b) establishing baseline extremity stiffness characteristics according to the method of claim 47;
(c) actuating the hydraulic pump;
(d) repeating the method of claim 47, wherein steps (b) through (k) are performed at a first, higher fluid fill rate, and wherein steps (b) through (k) are repeated at a second lower fluid fill rate to establish the fill rate dependency in the baseline extremity stiffness characteristics at said lower rate; and
(e) comparing the extremity stiffness characteristics with baseline extremity stiffness characteristics;
wherein a statistically significant change in the extremity stiffness characteristics at either of said higher or lower fluid fill rates is an indicator of the presence of deep vein thrombosis in the extremity.

49. The method of claim 48 wherein a statistically significant increase in temperature is an indicator of the presence of deep vein thrombosis in the extremity.

50. A portable device for applying compression to an extremity of a mammal comprising:
more than one cuff, each cuff comprising;
a closed bladder system;
incompressible fluid in said closed bladder system; and
a hydraulic pump,
wherein said cuffs are controlled by a single battery operated control unit removably attached to one of said cuffs.

51. The method of claim 45, wherein the actuating in said cuffs is sequential, intermittent, or concurrent.

52. The method of claim 45, wherein the compression cycling in said devices is asynchronous or synchronous.
